(19) United States
(12) Patent Application Publication
(10) Pub. No.: US 2007/0287822 A1
(43) Pub. Date: Dec. 13, 2007

(54) LIGHT ABSORBING COMPOSITIONS

(75) Inventors: Jason Clay Pearson, Kingsport, TN (US); Max Allen Weaver, Kingsport, TN (US); Timothy Ray Dawsey, Warsaw, IN (US); Greg Alan King, Mount Carmel, TN (US); Mark Dwight Clark, Kingsport, TN (US); James Lon Little, Kingsport, TN (US); Martin Frederick Schick, Kingsport, TN (US)

Correspondence Address: ERIC D. MIDDLEMAS;EASTMAN CHEMICAL COMPANY, P. O. BOX 511, KINGSPORT, TN, 37662-5075, US

(73) Assignee: EASTMAN CHEMICAL COMPANY, Kingsport, TN (US)

(21) Appl. No.: 11/423,783

(22) Filed: Jun. 13, 2006

(51) Int. Cl. B32B 27/00; C08G 18/00; C08G 63/02

(52) U.S. Cl. 528/44; 428/411.1; 528/272

(57) ABSTRACT

Disclosed are light absorbing compositions that are useful for marking or tagging articles for security identification, processes for the preparation of the light-absorbing compositions, coating compositions containing the light absorbing compositions and articles coated with the coating compositions.

### FIELD OF THE INVENTION

This invention pertains to the fields of polymer chemistry and chemistry of light-absorbing compositions. More specifically, this invention pertains to light-absorbing compositions that are useful for marking or tagging articles for security identification. This invention also pertains to processes for the preparation of the light-absorbing compositions, coating compositions containing the light-absorbing compositions and articles coated with the coating compositions.

### BACKGROUND OF THE INVENTION

The preparation of methine, light-absorbing compounds containing reactive groups and the copolymerization of such reactive, light-absorbing compounds into polycondensation polymers, particularly to impart color and UV light absorbing properties to polyesters, polyamides and polyurethanes, are known. See, for example, U.S. Pat. No. 4,617,373; U.S. Pat. No. 4,707,537; U.S. Pat. No. 4,749,773; U.S. Pat. No. 4,749,474; U.S. Pat. No. 4,845,187; U.S. Pat. No. 4,950,732; U.S. Pat. No. 5,030,708; U.S. Pat. No. 5,106,942 and U.S. Pat. No. 5,274,072. Futhermore, U.S. Pat. No. 5,086,161 discloses polyesters prepared from methine compounds that absorb both ultra violet (UV) light and visible light in about the range of 390 nm to 450 nm, thus imparting yellow color to the polyester while also providing UV light protection. None of these known polycondensation polymers provide a plurality of absorption bands in the light absorption spectrum to make them useful for marking and tagging for identification purposes as do the light-absorbing compositions of this invention, rendering the present materials advantages for marking or tagging purposes.

U.S. Pat. No. 4,619,990 discloses the preparation of a polyester containing residues of N,N-bis(2-hydroxyethyl)aniline into polyester. The pendant aromatic ring of the copolymerized N,N-bis(2-hydroxyethyl)aniline is formylated by treating the polymer with Vilsmeier reagent (a reaction product of POCl₃ and N,N-dimethylformamide) and the resulting aromatic aldehyde is reacted with an active methylene compound to form a light-absorbing composition. These compounds are useful as coloring and light-absorbing agents, particularly as the light-absorbing agents in thin optical recording layers. U.S. Pat. No. 4,619,990 does not disclose any polymer containing a plurality of methine chromophores. Infrared fluorescent compounds and polymeric compositions thereof have been proposed for tagging articles for identification and authentification: U.S. Pat. No. 5,292,855; U.S. Pat. No. 5,336,714; U.S. Pat. No. 5,423,432; U.S. Pat. No 5,461,136; U.S. Pat. No. 5,553,714; U.S. Pat. No. 5,614,008; U.S. Pat. No. 5,665,151; U.S. Pat. No. 5,990,197 and U.S. 6,197,851. These patents relate to the marking or tagging of a variety of substances with near infrared fluorescent compounds and compositions thereof, wherein the emitted infrared light is measured using an infrared light detection system or device. This technology is limited by the cost of suitable infrared fluorophores and the burdensome methods required for their preparation. The suitable polymer preparations thereof are limited to the use of monomeric infrared fluorescent compounds which are reactive and extremely thermally stable and which impart a minimum of color in the final composition, thus resulting in an expensive and complicated method for tagging.

### BRIEF SUMMARY OF THE INVENTION

The present invention provides light-absorbing compounds, oligomers and polymers that contain a plurality of covalently-bound methine chromophores that exhibit spectral characteristics in the ultraviolet, visible and/or infrared portions of the electromagnetic spectrum and are useful for tagging or marking substrates for identification purposes. The light-absorbing compounds, oligomers and polymers of the present invention have the formulas:

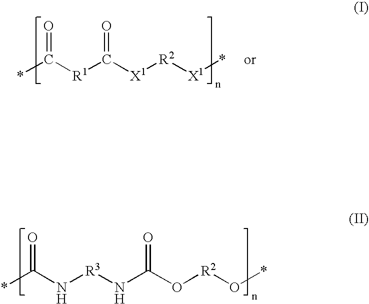

wherein

R¹ is selected from C₁-C₁₂-alkylene, C₃-C₈-cycloalkylene, carbocyclic arylene, divalent residues of a plurality of methine compounds; and a combination of any two or more thereof;

R² is selected from C₂-C₁₂-alkylene; —C₂H₄(OC₂H₄)ₚ—, wherein p is 1 to about 100; C₃-C₈-cycloalkylene; C₁-C₁₂-alkylene-C₃-C₈-cycloalkylene-C₁-C₁₂-alkylene; divalent residues of a plurality of methine compounds; and a combination of any two or more thereof;

R³ is selected from C₄-C₁₂-alkylene; C₃-C₈-cycloalkylene; and carbocyclic arylene;

X¹ is —O— or —N(R⁴)—, wherein R⁴ is hydrogen, C₁-C₂₂-alkyl, substituted C₁-C₂₂-alkyl, C₃-C₈-cycloalkyl or carbocyclic aryl; and

n is a integer from 2 to about 100;

wherein the divalent residues of a plurality of methine compounds have the formulas:

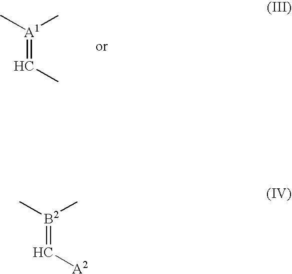

wherein

A¹ in combination with (i) the carbonyl groups to which R¹ is bonded or (ii) the X¹ groups to which R² is bonded is the divalent residues of an active methylene component of a light-absorbing methine compound;

B¹ represents the residues of a plurality of electron rich carbocyclic or heterocyclic aryl components of light-absorbing methine compounds;

B² in combination with (i) the carbonyl groups to which R¹ is bonded or (ii) the X¹ groups to which R² is bonded is the divalent residues of an electron rich carbocyclic or heterocyclic aryl component of a light-absorbing methine compound;

A² represents the residues of a plurality of active methylene components of light-absorbing methine compounds;

wherein the compounds, oligomers and polymers of formulas (I) and (II) contain at least two different B¹ groups or at least two different A² groups.

second embodiment of our invention is a coating composition containing at least one of the compounds, oligomers or polymers of formulas (I) and/or (II). A third embodiment of the present invention is an article coated with the coating composition containing at least one of the compounds, oligomers or polymers of formulas (I) and/or (II). The coating of the third embodiment has a characteristic absorbance which establishes the source or authenticity of the article coated with the coating composition. The absorbance may be changed periodically by changing the relative amounts of the different methine chromophores of the compositions of formulas (I) and/or (II).

A fourth embodiment of the invention is a process for the preparation of the compounds, oligomers and polymers of formulas (I) and (II) which comprises contacting a compound, oligomer or polymer having the formula:

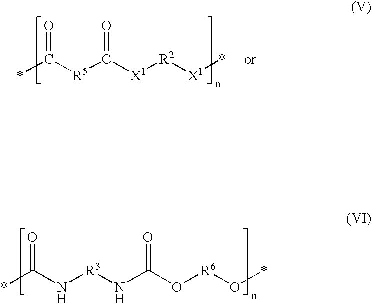

with a plurality of active methylene compounds having the formula A²-H₂, a plurality of carbocyclic or heterocyclic aryl aldehydes having the formula OCH—B¹, or a combination thereof;
wherein

R⁵ is selected from C₁-C₁₂-alkylene; C₃-C₈-cycloalkylene; carbocyclic arylene; a divalent residue having the formula

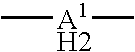

containing an active methylene, i.e., the residue of an active methylene compound capable of reacting with an aromatic aldehyde to form a light-absorbing methine compound; a divalent residue of an aromatic aldehyde having the formula

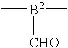

i.e., the residue of an aromatic aldehyde capable of reacting with an active methylene compound to form a light-absorbing methine compound and a combination of any two or more thereof;

R⁶ is selected from C₂-C₁₂-alkylene; C₂H₄(OC₂H₄)ₚ— wherein p 1 to about 100; C₃-C₈-cycloalkylene; C₁-C₁₂-alkylene-C₃-C₈-cycloalkylene- C₁-C₁₂-alkylene; a divalent, active methylene-containing residue having the formula

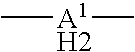

i.e., the residue of an active methylene compound capable of reacting with an aromatic aldehyde to form a light-absorbing methine compound; a divalent aldehyde-containing residue having the formula

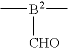

i.e., the residue of a carbocyclic or heterocyclic aryl aldehyde capable of reacting with an active methylene compound to form a light-absorbing methine compound, or a combination of any two or more thereof; and

R³, X¹, n, A¹, A², B¹, and B² are defined above.

The asterisks in formulas I, II, V and IV above represent the positions on the monomeric units wherein bonding exists with another monomeric unit. The use of selected amounts of active methylene compounds having the formula A²-H₂ or a plurality of carbocyclic or heterocyclic aromatic aldehydes having the formula OCH—B¹ produces a composition of formula (I) or (II) that exhibits a characteristic absorbance. The absorbance of the composition may be modified simply by changing one or more of the active methylene compounds or the aromatic aldehydes or, more simply, by changing the relative amounts of the same active methylene compounds or the same carbocyclic or heterocyclic aryl aldehydes used. When affixed to articles of commerce, e.g., by means of a coating on packaging materials, the compositions of formula (I) or (II) may be used to establish the source of articles or otherwise authenticate articles of commerce.

### DETAILED DESCRIPTION

The compositions of formulas (I) and (II) include polyesters including copolyester, polyamides, polyesteramides and polyurethanes typically having weight average (M_{w}) molecular weights of about 1,000 to 50,000, preferably about 1,000 to 25,000, most preferably about 1,000 to 10,000. In formulas (I) and (II), n preferably is about 3 to 50 and p preferably is 1 to 3. The oligomeric or polymeric compositions of formulas (I) and (II) are terminated with functional groups of the reactants used to prepare the compositions. Examples of such functional groups include carboxyl, alkoxycarbonyl, hydroxyl, amino and isocyanato. Any terminal isocyanato groups may, and normally do, react with other hydrogen-containing nucleophiles such as water, alcohols, alkyl amines and the like.

Examples of the active methylene compounds having the formula A²-H₂ include compounds having the formulas:

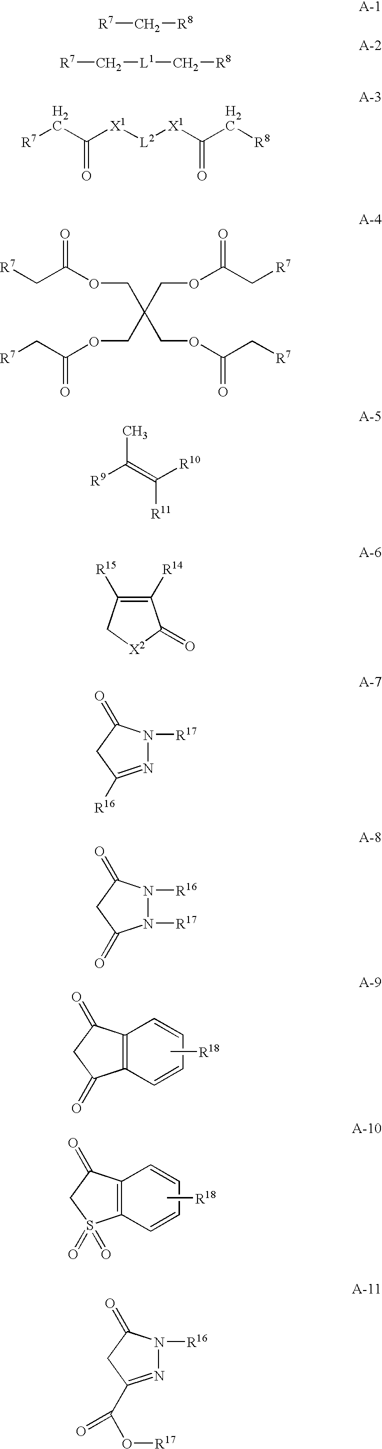

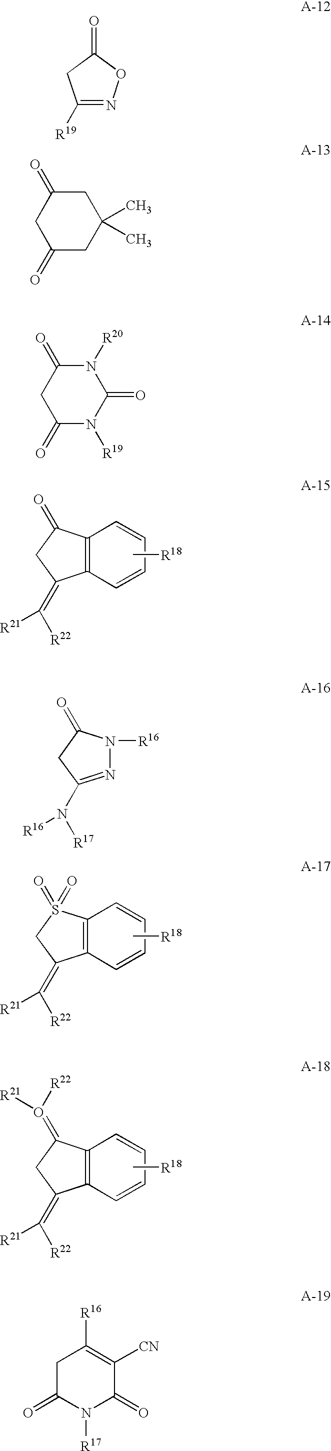

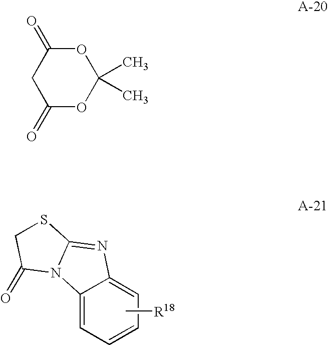

wherein

R⁷ and R⁸ each is an electron withdrawing group independently selected from aryl, carbamoyl, cyano, heteroaryl, nitro, sulfamoyl, —COR¹², —COOR¹², —CONHR¹², —CON(R¹²)R¹³, —SO₂R¹², —SO₂NHR¹², and —SO₂N(R¹²)R¹³;

R⁹ is selected from carbocyclic aryl and heterocyclic aryl;

R¹⁰ and R¹¹ each is independently selected from cyano, C₁-C₆-alkylsulfonyl, arylsulfonyl and C₁-C₆-alkoxycarbonyl;

R¹² and R¹³ individually are independently selected from C₁-C₂₂-alkyl; substituted C₁-C₂₂-alkyl, including groups having the formula -L²-OH and -L³-OH; —C₂H₄(OC₂H₄)ₚ—OH; C₃-C₈-cycloalkyl; substituted C₃-C₈-cycloalkyl; C₃-C₈-alkenyl; C₃-C₈-alkynyl; carbocyclic aryl; heterocyclic aryl; and R¹² and R¹³ collectively with the nitrogen atom to which R¹² and R¹³ are bonded may represent a cyclic group selected from pyrrolidino, piperidino, morpholino, piperazino, thiomorpholino and thiomorpholino-S,S-dioxide;

R¹⁴ is selected from C₁-C₆-alkoxycarbonyl, carboxy, carbamoyl, —CONHR¹², ——CON(R¹²)R¹³, cyano and heterocyclic aryl;

R¹⁵ is selected from carbocyclic aryl and heterocyclic aryl;

R¹⁶ and R¹⁷ each is independently selected from hydrogen, C₁-C₆-alkyl, —C₂H₄(OC₂H₄)ₚ—OH, substituted C₁-C₆-alkyl, C₃-C₈-cycloalkyl and carbocyclic aryl;

R¹⁸ is selected from hydrogen, C₁-C₆-alkyl, C₁-C₆-alkoxy, halogen, cyano, C₁-C₆-alkoxycarbonyl, trifluoromethyl, hydroxy, C₁-C₆-alkanoyloxy, aroyl, C₁-C₆-alkylthio, C₁-C₆-alkylsulfonyl, carbamoyl, sulfamoyl, —NHCOR¹², —NHSO₂R¹², —CONHR¹², —CON(R¹²)R¹³, —SO₂NHR¹² and —SO₂N(R¹²)R¹³.

R¹⁹ and R²⁰ are selected from hydrogen, C₁-C₆-alkyl, substituted C₁-C₆-alkyl and carbocyclic aryl;

R²¹ and R²² each is independently selected from cyano, C₁-C₆-alkylsulfonyl, carbocyclic arylsulfonyl, C₁-C₆-alkoxycarbonyl and heterocyclic aryl;

L¹ is arylene;

L² and L³ each is a divalent linking group selected from C₂-C₂₂-alkylene, C₃-C₈-cycloalkylene, C₁-C₆-alkylene-cyclohexylene-C₁-C₆-alkylene, C₂-C₄-alkylene-O-arylene-O—C₂-C₄-alkylene, arylene and —(CH₂CH₂-L₄)₁₋₃-CH₂CH₂—, wherein L₄ is selected from —O—, —S—, —SO₂—, and —N(R⁴)—;

X² is selected from —O—, —S— and —N(R⁴)—; and

p, R⁴ and X¹ are defined above.

When substituted with ester- or amide-forming reactive groups such as carboxy, alkoxycarbonyl, hydroxyl and/or amino as described hereinafter, the active methylene compounds having formulas A-1 through A-21 are examples of the residues represented by -A¹- in the structures

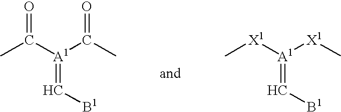

Examples of the electron rich carbocyclic and heterocyclic aromatic groups represented by B¹ include radicals having the formulas:

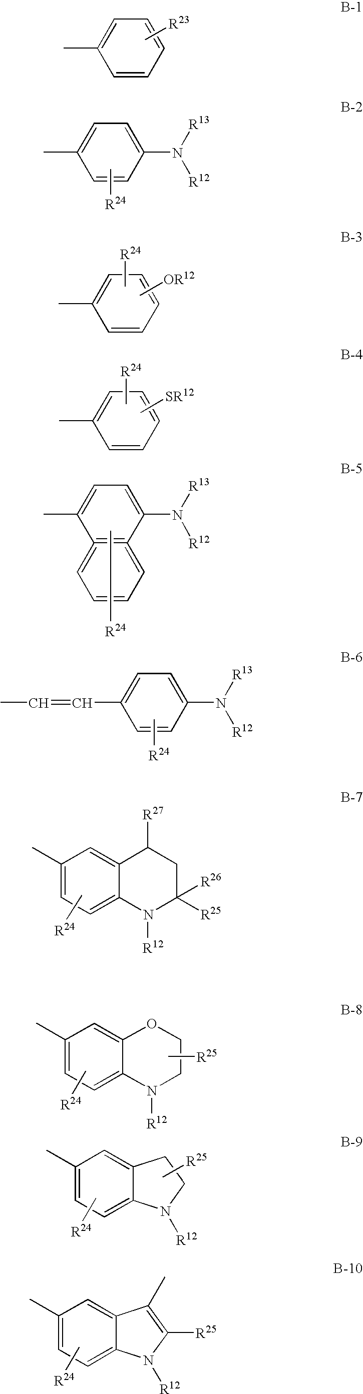

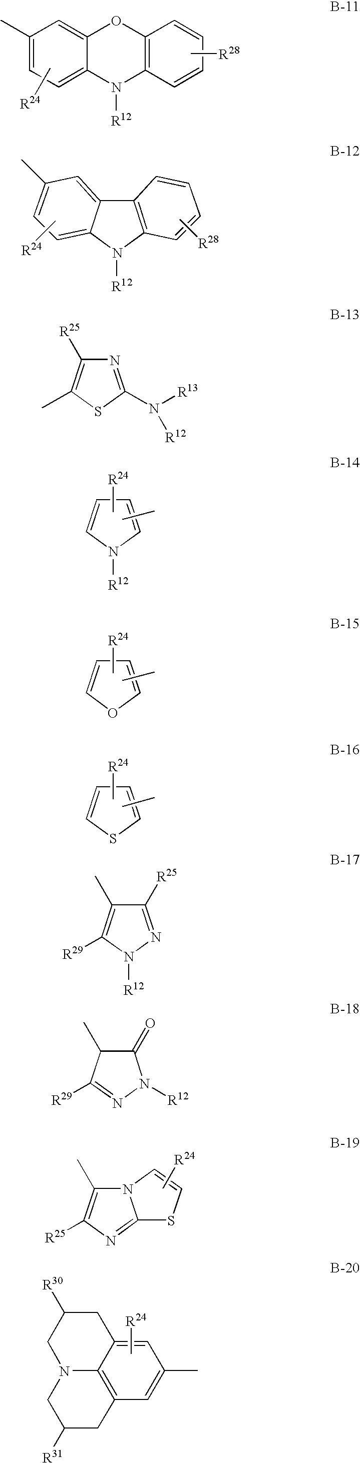

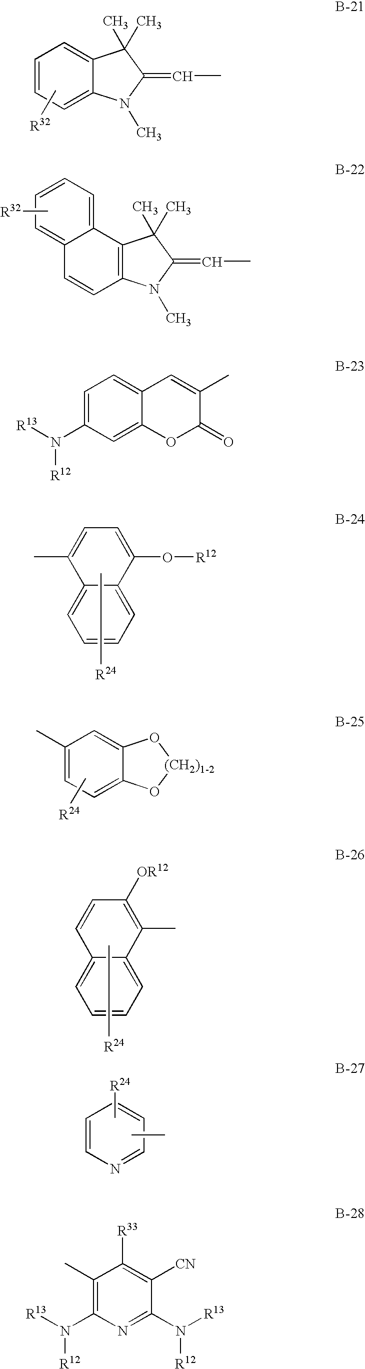

wherein:

R²³ is selected from hydrogen and one or two groups selected from carboxy, C₁-C₆⁻ alkoxycarbonyl, —CON(R¹²R¹³, —N(R¹⁶)COR¹⁷, —N(R¹⁶)SO₂R³⁴, —N(R¹⁶)CON(R¹⁶)R¹⁷, succinimido, phthalimido, halogen, nitro, trifluoromethyl, —OCOR³⁴ and carbocyclic aryl;

R²⁴ is selected from hydrogen and one or two groups selected from C₁-C₆-alkyl substituted C₁-C₆-alkyl, C₁-C₆-alkoxy and hydrogen;

R²⁵ is selected from hydrogen, C₁-C₆-alkyl and aryl;

R²⁶ and R²⁷ are selected from hydrogen and C₁-C₆-alkyl;

R²⁸ is selected from hydrogen and one or two groups selected from C₁-C₆-alkyl, C₁-C₆-alkoxy and halogen;

R²⁹ is selected from hydrogen, C₁-C₆-alkyl, C₃-C₈-cycloalkyl, aryl, —CO₂R¹⁶ and —N(R¹²)R¹³;

R³⁰ and R³¹ are selected from hydrogen and C₁-C₆-alkyl;

R³² is selected from hydrogen, C₁-C₆-alkyl, C₁-C₆-alkoxy, carboxy and —CO₂R¹⁷;

R³³ is selected from C₁-C₆-alkyl, C₃-C₈-cycloalkyl and carbocyclic and heterocyclic aryl;

R³⁴ is selected from C₁-C₆-alkyl, C₃-C₈-cycloalkyl and carbocyclic aryl; and

R^{12,} R¹³, R¹⁶ and R¹⁷ are defined above.

The compositions of formulas (I) and (II) may be prepared by contacting the compositions of formulas (V) and (VI) with a plurality of active methylene compounds having formula A²-H₂, a plurality of carbocyclic or heterocyclic aryl aldehydes having formula OHC—B¹, or a combination thereof. The process for preparing the compositions of formulas (I) and (II) typically is carried out at temperatures in the range of about 25 to 150° C., preferably about 25 to 125° C. The reaction of the active methylene compounds and/or aldehyde compounds with the compositions of formulas (V) and (VI) may be carried out in the melt phase or in the liquid phase using an inert, organic solvent such as an aliphatic or aromatic hydrocarbon, e.g., toluene and xylene, or N,N-dimethylformamide (DMF). The process normally is carried out in the presence of a basic catalyst known to catalyze the Knoevenagel condensation reaction. Preferred catalysts are sodium acetate and piperidine acetate.

The compounds, oligomers and polymers of formulas (I), (II), (V) and (VI) comprise polyesters, polyamides, polyesteramides and polyurethanes. Typical polyesters in which functional active methylene compounds and carbocyclic and heterocyclic aryl aldehydes may be incorporated include those disclosed in U.S. Pat. No. 2,465,319; U.S. Pat. No. 3,668,277; U.S. Pat. No. 3,560,445 and BP 578,079. In general, any polyamide, polyester or polyesteramide may be used in accordance with the present invention. Typical polyamides are those disclosed in U.S. Pat. No. 3,560,448; U.S. Pat. No. 3,562,206; U.S. Pat. No. 4,252,920; U.S. Pat. No. 4,237,251; U.S. Pat. No. 4,438,240; U.S. Pat. No. 4,420,603; U.S. Pat. No. 4,402,602; U.S. Pat. No. 4,436,898; U.S. Pat. No. 4,436,972 and U.S. Pat. No. 4,251,653 and the references cited therein. Typical polyurethanes and their preparation are described by D. J. Lyman, Journal of Polymer Science, Vol. XLV, pp 49-59 (1960)] and U.S. Pat. No. 5,194,463.

The compositions of formulas (V) and (VI) may be prepared by reacting and/or polymerizing the appropriate monomers selected from dicarboxylic acids and/or ester-producing equivalents such as dialkyl esters and diacid halides of dicarboxylic acids, hydroxycarboxylic acids, lactones, lactams,diisocyanates, diols and diamines. The reaction or polymerization may be carried out using conditions and catalysts typically used in the preparation of polyesters, polyamides, polyester-amides and polyurethanes. Examples of suitable diacid components are residues derived from aliphatic, alicyclic and aromatic dicarboxylic acids such as terephthalic acid, isophthalic acid, 1,4-cyclohexanedicarboxylic acid, 1,3-cyclohexanedicarboxylic acid, succinic acid, glutaric acid, adipic acid, sebacic acid, 1,12-dodecanedioic acid, 2,6-naphthalenedicarboxylic acid and the like. Diesters such as the dimethyl, diethyl, or dipropyl ester of the dicarboxylic acid as well as anhydrides or acid halides of these diacids also may be employed where practical.

Examples of the diols that may be used in the preparation of the compositions of formulas (V) and (VI) include ethylene glycol, 1,2-propanediol, 1,3-propanediol, 2-methyl-1,3-propanediol, 1,4-butanediol, 2,2-dimethyl-1,3-propane-diol, 1,6-hexanediol, 1,10-decanediol, 1,12-dodecanediol, 1,2-cyclohexanediol, 1,3-cyclobutanediol, 2,2,4,4-tetramethylcyclobutane-1,3-diol, 1,4-cyclohexanediol, 1,2-cyclohexanedimethanol, 1,3-cyclohexanedimethanol, 1,4-cyclohexane-dimethanol, z,8-bis(hydroxymethyl)-tricyclo-[5.2.1.0]-decane, wherein z represents 3, 4, or 5; and diols containing one or more oxygen or sulfur atoms in the chain, e.g., diethylene glycol, 2,2′-thiodiethanol, triethylene glycol, dipropylene glycol, tripropylene glycol, 1,3- and 1,4-bis(2-hydroxyethyl)benzene and the like. In general, these diols contain 2 to 18, preferably 2 to 12, carbon atoms. Cycloaliphatic diols may be employed in their cis or trans configuration or as mixtures of both forms. U.S. Pat. No. 6,121,351 discloses a variety of diamines that may be used in preparing the polyamide and polyesteramide compositions of formula (V).

The polyurethane compositions of formula (VI) may be prepared by reacting one or more diols having aliphatic hydroxyl groups with a diisocyanate under solution polymerization procedures known to be useful for preparing polyurethanes. See, for example, D. J. Lyman, Journal of Polymer Science, Vol. XLV, pp. 49-59 (1960). Typical useful diisocyanates include 2,4-tolylene diisocyanate, 2,6-tolylene diisocyanate, mixtures of 2,4 and 2,6-tolylene diisocyanate, 4,4′-biphenylene diisocyanate, p-xylylene diisocyanate, methylenedi-p-phenyl diisocyanate, m-phenylene diisocyanate, p-phenylene diisocyanate, hexamethylene diisocyanate, isophorone diisocyanate, 4,4′-diisocyanatodiphenyl ether, bis(4-isocyanatophenyl)-sulfone, isopropylidene bis(4-phenyl isocyanate), naphthalene-1,5-diisocyanate, 1-chloro-2,4-phenylene diisocyanate, 3,3′-bitolylene-4,4′-diisocyanate, 3,3′-dimethoxy-4,4′-biphenylene diisocyanate, 3,3′-dichloro-4,4′-biphenylene diisocyanate, 2,2′, 5,5′-tetramethyl-4,4′-biphenylene diisocyanate, diphenylethane-4,4′-diisocyanate, dicyclohexylmethane-4,4′-diisocyanate, and the like.

As is specified above, some or all of the dicarboxylic acid residues, i.e., the residues represented by —CO—R⁵—CO— in formula (V), or some or all of the diol and diamine residues, i.e., the residues represented by —X¹—R²—X¹— and —O— R⁶—O in formulas (V) and (VI), are residues of one or more active methyene compounds having the formula

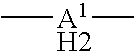

i.e., the residue of an active methylene compound capable of reacting with an aromatic aldehyde to form a light-absorbing methine compound; a divalent residue of a carbocyclic or heterocyclic aryl aldehyde having the formula

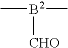

i.e., the residue of an aromatic aldehyde capable of reacting with an active methylene compound to form a light-absorbing methine compound and a combination of any two or more thereof. The active methylene compounds and aryl aldehydes that are reacted or copolymerized into the compositions of formulas (V) and (VI) bear two reactive groups that enable reaction or polycondensation into the polmer chain. Reactive groups for incorporating the active methylene compounds and aryl aldehydes into polyester include hydoxy, carboxy and ester groups having the formulae: —OOCR³⁵, —CO₂R³⁵ and —OCON(R³⁶)R³⁵, wherein R³⁵ is selected from C₁-C₆-alkyl, C₃-C₈-cycloalkyl and aryl and R³⁶ is selected from hydrogen, C₁-C₆-alkyl, C₃-C₈-cycloalkyl and aryl. The preferred reactive groups on the monomeric active methylene compounds and aryl aldehydes to be incorporated into polyamides are carboxy, —NH₂ and —NHR⁴. For incorporation into polyurethanes the active methylene and aldehyde monomers preferably contain two aliphatic hydroxy groups. For production of polyesteramides, the active methylene and aldehyde monomers contain one aliphatic hydroxy and one amino group. Mixtures of active methylene and aldehyde monomers containing different reactive groups such as two polyester reactive groups and two amino groups also may be utilized.

Examples of active methylene compounds that have suitable functional groups or that may be functionalized by known procedures and are useful for practice of the invention are described in U.S. Pat. No. 4,617,373; U.S. Pat. No. 5,030,708; U.S. Pat. No. 5,086,161; U.S. Pat. No. 5,106,942; U.S. Pat. No. 5,274,072; and U.S. Pat. No. 5,376,650. The methine compounds in these patents have only one significant absorption band in the ultra violet and visible spectra. A plurality of these methine compounds, when combined and formulated into a coating composition, gives a plurality of absorption bands needed for marking and tagging, but the individual methine compounds tend to migrate, exude, extract, etc., which limits their utility in contrast to the polymeric compositions of this invention wherein the methine chromophore is part of the polymeric composition. These same active methylene compounds and similar compounds that contain no polyester reactive functional groups are also useful for reacting with the polymers of the present invention that contain copolymerized difunctional aldehyde compounds to produce light absorbing polymers that contain light absorbing methine chromophores. U.S. Pat. No. 4,617,373 discloses several active methylene compounds. Typical difunctional aromatic compounds that may be converted into useful difunctional aldehydes are those of the classes shown in U.S. Pat. No. 4,614,373. Such difunctional aromatic compounds are normally prepared by the Vilsmeier reaction on electron rich aromatic compounds, which contain suitable functional groups, or which have functional groups that can be converted into aldehydes by known methods such as oxidation of primary alcohols, reduction of esters, reduction of esters to primary alcohols followed by oxidation to the aldehyde and the like.

Examples of diacid- or diester-functionalized, active methylene compounds useful for preparing the compositions of formulas (V) and (VI) include dialkyl malonates and compounds having the structures M-1 through M-11:

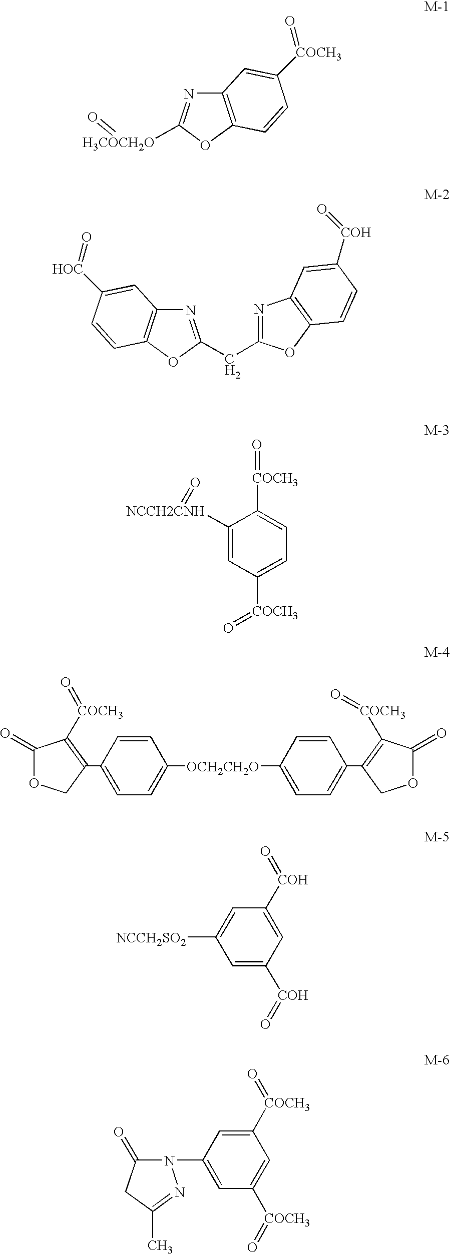

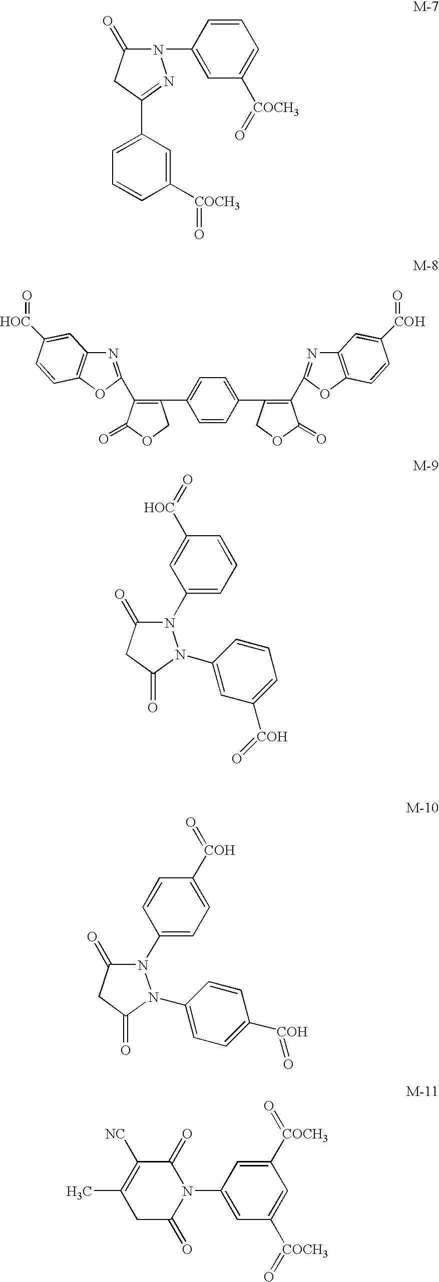

Examples of diol -functionalized, active methylene compounds useful for preparing the compositions of formulas (V) and (VI) include compounds having the structures M-12 through M-21:

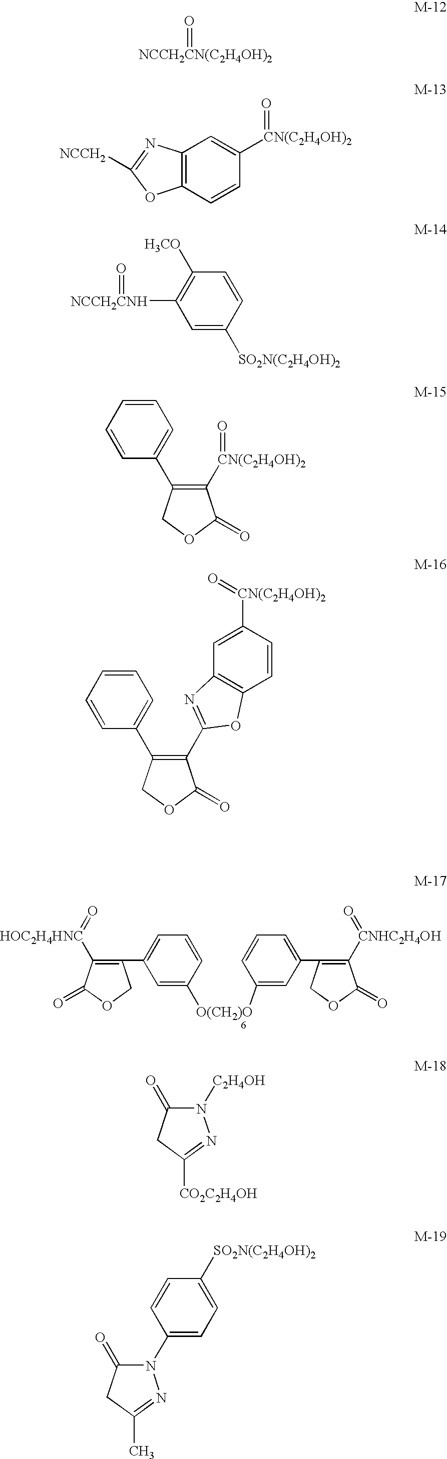

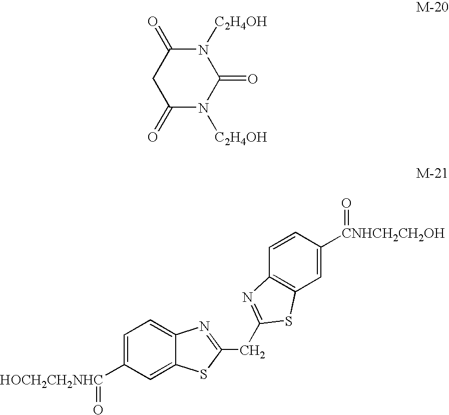

### The active methylene compounds may be functionalized with an hydroxyl group and an acid or ester group, e.g., compounds having the structures M-22 and M-23:

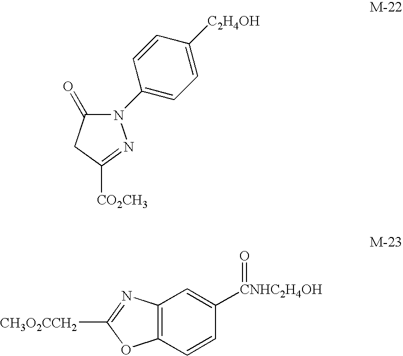

The functionalized aldehydes useful for preparing the compositions of formulas V and VI include compounds having structures B¹—CHO, wherein B¹— contains two reactive groups listed above in paragraph 0015. Any of the structures mentioned above for B-1 through B-28 are useful when bonded to an aldehyde group and properly functionalized with two reactive groups. Also, the aldehyde precursors, B¹—H that are properly functionalized with reactive groups may be reacted to prepare intermediate oligomers or polymers. These intermediates may be reacted with the Vilsmeier reagent in solvents such as N,N-dimethylformamide to produce compositions having structures (V) and (VI). Of particular utility are the aldehydes or precursors having structures B¹—CHO or B¹—H, respectively, wherein B¹— is selected from B-2, B-3, B-6, B-7, B-13, B-18, B-24, B-26 and B-28, wherein there are two reactive groups present on the R¹² substituent and another reactive group on another substituent such as R¹³, R²⁴, R²⁵, R²⁹, etc.

The terms “C₁-C₂₂-alkyl” and “C₁-C₆-alkyl”, denote saturated hydrocarbon radicals or moieties that contains one to twenty-two carbons and one to six carbons, respectively, and which may be straight or branched-chain. Such C₁-C₂₂-alkyl and C₁-C₆-alkyl, groups can be selected from methyl, ethyl, propyl, butyl, pentyl, hexyl, heptyl, octyl, isopropyl, isobutyl, tertbutyl, neopentyl, 2-ethylheptyl, 2-ethylhexyl, and the like and these groups substituted with one to two common groups selected from hydrogen, cyano, halogen, carboxy, aryl, —OC₁-C₄-alkyl, —CO₂C₁-C₄-alkyl, —O₂COC₁—C₄-alkyl and —O₂C—C₁-C₄-alkyl, wherein the C₁-C₄-alkyl portion of the group represents a saturated straight or branched chain hydrocarbon that contains one to four carbon atoms.

The terms “substituted C₁-C₂₂-alkyl” and “substituted C₁-C₆-alkyl” refer to C₁-C₂₂-alkyl radicals and C₁-C₆-alkyl radicals as described above that may be substituted with one or more substituents selected from hydroxy, halogen, cyano, carboxy, aryl, succinimido, phthalimido, phthalimidino, 2-pyrrolidino, C₃-C₈-cycloalkyl, heterocyclic aryl, vinylsulfonyl, o-benzoic sulfimido, —OR³⁶, —SR³⁷, —SO₂R³⁸, —SO₂CH₂CH₂SR³⁷, —CON(R³⁹)R⁴⁰, SO₂N(R³⁹)R⁴⁰, —O₂CN(R^{39)R}₄₀, —OCOR³⁸, —OCO₂R³⁸, —N(R³⁹)SO₂R³⁸, —N(R³⁹)COR³⁸,

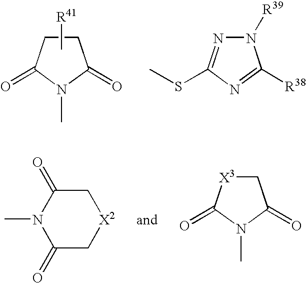

wherein

R³⁶ is selected from C₁-C₆-alkyl, C₃-C₈-cycloalkyl, C₃-C₈-alkenyl and carbocyclic aryl;

R³⁷ is selected from C₁-C₆-alkyl, C₃-C₈-cycloalkyl and carbocyclic and herocyclic aryl;

R³⁸ is selected from C₁-C₆-alkyl, substituted C₁-C₆-alkyl, C₃-C₈-cycloalkyl, and carbocyclic aryl;

R³⁹ and R⁴⁰ are independently selected from hydrogen, C₁-C₆-alkyl, substituted C₁-C₆-alkyl, C₃-C₈-cycloalkyl and carbocyclic aryl;

R⁴¹ is selected from hydroxy and C₁-C₆-alkanoyloxy;

X² is defined above; and

X³ is selected from C₂-C₄-alkylene, —O—, —S—, and —N(R³⁹)—.

The terms “C₁-C₆-alkoxy”, “C₁-C₆-alkylthio”, “C₁-C₆-alkylsulfonyl”, “C₁-C₆-alkoxycarbonyl”, and “C₁-C₆-alkanoyloxy” are used to denote the following radicals, respectively: —OC₁-C₆-alkyl, —S—C₁-C₆-alkyl, —SO₂C₁ -C₆-alkyl, —CO₂C₁-C₆-alkyl, and —O₂C—C₁-C₆-alkyl, wherein the C₁-C₆-alkyl portion of the group may be substituted with up to two groups selected from hydroxy, cyano, halogen, carboxy, aryl, —OC₁-C₄-alkyl, —CO₂C₁-C₄-alkyl, —O₂COC₁-C₄-alkyl and —O₂C—C₁-C₄-alkyl, wherein the C₁-C₄-alkyl portion of the group represents a saturated straight or branched hydrocarbon chain that contains one to four carbon atoms.

The term “C₃-C₈-cycloalkyl”, “C₃-C₈-alkenyl” and “C₃-C₈-alkynyl” are used to denote saturated cycloaliphatic hydrocarbon radicals, straight or branched hydrocarbon radicals containing at least one carbon-carbon double bond and straight or branched hydrocarbon radicals containing carbon-carbon triple bonds, respectively, with each radical containing three to eight carbon atoms. The term “substituted C₃-C₈-cycloalkyl” is used to describe a C₃-C₈-cycloalkyl radical as detailed above containing at least one group selected from C₁-C₆-alkyl, C₁-C₆-alkoxy, hydroxy, halogen, and the like. The term “halogen” is used herein to denote fluorine, chlorine, bromine and iodine.

The terms “C₂-C₄-alkylene”, “C₁-C₆-alkylene”, C₂-C₁₂”, “C₁-C₁₂-alkylene” and “C₁-C₂₂-alkylene” are used to denote a saturated divalent straight or branched hydrocarbon radical containing two to four, one to six, two to twelve, one to twelve and one to twenty-two carbon atoms, respectively, and these radicals optionally substituted with up to two groups selected from hydroxy, halogen, cyano, carboxy C₁-C₆-alkanoyloxy and aryl. The term “C₃-C₈-cycloalkylene” is used to denote a saturated divalent cycloaliphatic radical that contains three to eight carbon atoms.

The terms “aryl” and “carbocyclic aryl” are used herein to denote a carbocyclic aromatic ring system containing 6,10 or 14 carbon atoms in the conjugated aromatic ring structure and these ring systems substituted with one or more groups selected from C₁-C₆-alkyl; C₁-C₆-alkoxycarbonyl; C₁-C₆-alkoxy; halogen; carboxy; hydroxyl; C₁-C₆-alkylsulfonyl; C₁-C₆-alkylthio; thiocyano; cyano; nitro; trifluoromethyl; phenyl and phenyl substituted with C₁-C₆-alkyl, C₁-C₆-alkoxy, halogen and the like. Typical aryl groups include phenyl, naphthyl, phenylnaphthyl, anthryl (anthracenyl) and the like. The terms “heteroaryl” and “heterocyclic aryl” are used to describe conjugated cyclic radicals containing at least one heteroatom selected from sulfur, oxygen, nitrogen or a combination of these in combination with from two to about ten carbon atoms and these ring systems substituted with one or more groups selected from C₁-C₆-alkyl; C₁-C₆-alkoxycarbonyl; C₁-C₆-alkoxy; halogen; carboxy; hydroxyl; C₁-C₆-alkylsulfonyl; C₁-C₆-alkylthio; thiocyano; cyano; nitro; trifluoromethyl; phenyl and phenyl substituted with C₁-C₆-alkyl, C₁-C₆-alkoxy, halogen and the like. Typical heteroaryl ring systems include: furyl, thienyl, pyrrolyl, imidazolyl, pyrazolyl, thiazolyl, isothiazolyl, oxazolyl, isoxazolyl, triazolyl, thiadiazolyl, oxadiazolyl, tetrazolyl, thiatriazolyl, oxatriazolyl, pyridyl, pyrimidyl, pyrazinyl, pyridazinyl, thiazinyl, oxazinyl, triazinyl, thiadiazinyl, oxadiazinyl, dithiazinyl, dioxazinyl, oxathiazinyl, tetrazinyl, thiatriazinyl, oxatriazinyl, dithiadiazinyl, imidazolinyl, dihydropyrimidyl, tetrahydropyrimidyl, tetrazolo-[1,5-b]pyridazinyl and purinyl, benzoxazolyl, benzothiazolyl, benzimidazolyl, indolyl, and the like.

The term “arylene” and “carbocyclic arylene” are used to denote a divalent, carbocyclic, aromatic radicals such as 1,2-, 1,3-, and 1,4-phenylene and naphthylene and divalent, carbocyclic, aromatic radicals optionally substituted with one or more groups selected from C₁-C₆-alkyl, C₁-C₆-alkoxy, halogen, carboxy, hydroxyl, C₁-C₆-alkoxycarbonyl, C₁-C₆-alkylsulfonyl, C₁-C₆-alkythio, thiocyano, cyano, nitro and trifluoromethyl.

The references herein to groups or moieties having a stated range of carbon atoms such as C₁-C₄-alkyl, C₁-C₆-alkyl, C₁-C₁₂-alkyl, C₃-C₈-cycloalkyl, C₃-C₈-alkenyl, C₁-C₁₂-alkylene, C₁-C₆-alkylene, includes moieties of all of the number of carbon atoms mentioned within the ranges. For example, the term “C₁-C₆-alkyl” includes not only the C₁ group (methyl) and C₆ group (hexyl) end points, but also each of the corresponding C₂, C₃, C₄, and C₅ groups including their isomers. In addition, it will be understood that each of the individual points within a stated range of carbon atoms may be further combined to describe subranges that are inherently within the stated overall range. For example, the term “C₃-C₈-cycloalkyl” includes not only the individual cyclic moieties C₃ through C₈, but also contemplates subranges such as C₄-C₆-cycloalkyl.

The light-absorbing compositions of the present invention preferably contain divalent residues of a plurality of methine compounds of formula (III). The preferred light-absorbing compositions have formula (I) wherein X¹ is oxygen, i.e., light-absorbing polyesters. The divalent residues of a plurality of methine compounds of formulas (III) or (IV) constitute about 10 to 100 mole percent of the diacid residues of formula (I), i.e., the residues having the formula —CO—R¹—CO— or about 10 to 100 mole percent of the diol residues of formula (I), i.e., the residues having the formula —X¹—R²—X¹— wherein X¹ is oxygen, i.e., —O—. The most preferred light-absorbing compositions have formula (I) wherein X¹ is oxygen and the divalent residues of a plurality of methine compounds having the formula:

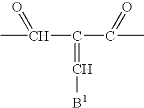

wherein B¹ represents a plurality of, preferably three, different carbocyclic aryl groups or heterocyclic aryl groups. These preferred compounds may be prepared by forming a first polyester by reacting a dialkyl malonate, optionally with one or more other dicarboxylic acid or diester monomers, with one or more aliphatic diols and then reacting the first polyester with a plurality of aldehydes having the formula

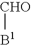

wherein B¹ is defined above. B¹ preferably represents a plurality of different carbocyclic aryl groups selected from formulas B-1, B-2 and/or B-3.

The coating compositions of the present invention comprise a solution of one or more light-absorbing compositions of formula (I) and/or (II) in a coating composition base comprising a film-forming polymeric material dissolved in an inert, organic solvent. The concentration of the light-absorbing composition typically is about 0.1 to 10, preferably 0.5 to 2, weight percent based on the total weight of the coating composition. The film-forming polymeric component of the coating compositions may be selected from a variety of known film-forming materials such as addition polymers, e.g., acrylic polymers, condensation polymers, e.g., polyesters, and semi-synthetic polymers, e.g., cellulose esters. The concentration of the film-forming polymeric material typically is about 10.0 to 50.0 weight percent, more typically about 15.0 to 30.0 weight percent, based on the total weight of the coating composition. The inert organic solvent may be selected from one or more organic liquids such as hydrocarbons, e.g., toluene, xylene and heptane; polyethers; alkanols; alkoxyalkanols; alkanoate esters, e.g., acetate esters of alkanols and diols. The solvent normally is volatile.

The coating compositions of the present invention may contain one or more additional components typically present in coating compositions. Examples of such additional components include leveling, rheology, and flow control agents such as silicones, fluorocarbons or cellulosics; flatting agents; pigment wetting and dispersing agents; surfactants; ultraviolet (UV) absorbers; UV light stabilizers; tinting pigments; defoaming and antifoaming agents; anti-settling, anti-sag and bodying agents; anti-skinning agents; anti-flooding and anti-floating agents; fungicides and mildewcides; corrosion inhibitors; plasticizers; thickening agents; and/or coalescing agents. The coating compositions of the present invention also may contain non-reactive modifying resins. Typical non-reactive modifying resins include homopolymers and copolymers of acrylic and methacrylic acid; homopolymers and copolymers of alkyl esters of acrylic and methacrylic acid such as methyl, ethyl, n-propyl, isopropyl, butyl, tetrahydrofurfuryl, cyclohexyl, isobornyl, n-hexyl, n-octyl, isooctyl, 2-ethylhexyl, lauryl, stearyl, and benzyl acrylate and methacrylate; acrylated and methacrylated urethane, epoxy, and polyester resins, silicone acrylates, cellulose esters such as cellulose acetate butyrates, cellulose acetate, propionates, nitro-cellulose, cellulose ethers such as methyl cellulose, ethyl cellulose, hydroxypropyl cellulose, and hydroxypropyl methyl cellulose. Typical plasticizers include alkyl esters of phthalic acid such as dimethyl phthalate, diethyl phthalate, dipropyl phthalate, dibutyl phthalate, and dioctyl phthalate; citrate esters such as triethyl citrate and tributyl citrate; triacetin and tripropionin; and glycerol monoesters such as Eastman 18-04, 18-07, 18-92 and 18-99 from Eastman Chemical Company. Specific examples of additional additives can be found in Raw Materials Index, published by the National Paint & Coatings Association, 1500 Rhode Island Avenue, N.W., Washington, D.C. 20005.

The coating compositions described herein may be applied to various articles by means of conventional procedures such as brushing and rolling. The resulting coating comprises a film of the film-forming polymeric material containing one or more of the light-absorbing compositions of formula (I) and/or (II). The coating compositions are especially useful for coating packaging materials used to package manufactured articles or tags or labels attached to manufactured articles for the purpose of identifying the source of the manufactured articles or goods. The characteristic absorbance of the coating containing a compoisition of formula (I) and/or (II) may be observed with a UV/Visible reflectance spectrometer. The coating compositions provided by the present invention also may comprise a melt of a film-forming polymer and having dissolved therein one or more of the light-absorbing compositions of formula (I) wherein X¹ is —O— and/or compositions of formula (II). The light-absorbing compositions of formula (I) and/or (II) having higher molecular weights may function as film-forming material and may be applied to articles or packaging materials in the absence of other film-forming polymers or solvents. Such film-forming compositions of formulas (I) and (II) typically will have a weight average molecular weight of about 5,000 to 50,000. The light-absorbing compositions of formula (I) and/or (II) may be added to bulk materials such as solid chemicals and liquid fuels to mark or establish the source and/or a particular lot of such bulk materials. The marking-effective concentration of the compositions of formulas (I) and/or (II) required to mark bulk materials typically is about 0.01 to 1.0 weight percent based on the total weight of the materials. Specific examples of such materials include explosives, fertilizers and gasoline.

### EXAMPLES

The light-absorbing compositions, coating compositions and coated articles provided by the present invention are further illustrated by the following examples wherein all percentages are by weight unless specified otherwise.

### Example 1

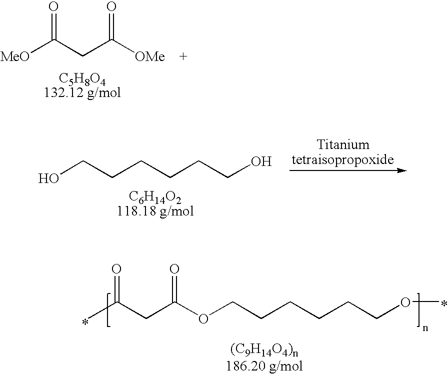

Dimethyl malonate (50.0 g, 0.38 mol), 1,6-hexanediol (44.73 g, 0.38 mol) and titanium (IV) isopropoxide (50 mg) were added to a 3-neck, 500 mL, round bottomed flask equipped with a mechanical stirrer and a Dean-Stark trap. The reaction mixture was heated with stirring to 150° C. and stirred under nitrogen until methanol distillation stopped. The resulting polyester was allowed to cool to room temperature.

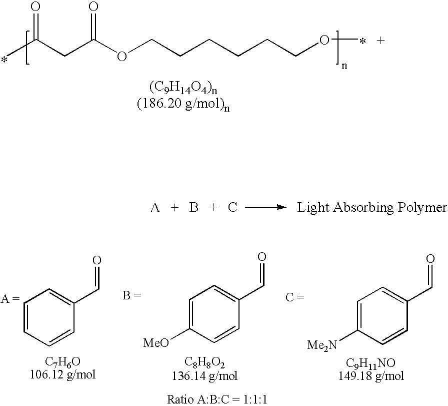

The polyester prepared as described in the preceding paragraph (5.0 g), benzaldehyde (770 mg, 7.26 mmol), 4-methoxybenzaldehyde (988 mg, 7.26 mmol), 4-dimethylaminobenzaldehyde (1.08 g, 7.26 mmol), toluene (75 mL) and piperidine acetate (100 mg) were added, respectively, to a 250 mL, 3-neck, round bottomed flask equipped with a magnetic stirrer and Dean-Stark trap. The reaction solution was heated to reflux and stirred until water distillation stopped (about 18 hours). The reaction mixture containing the light-absorbing polyester thus prepared was allowed to cool to room temperature and then concentrated to give 7.73 g of a light yellow oil.

### Example 2

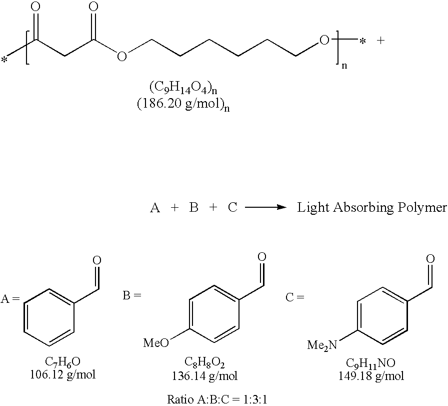

The polyester prepared as described in the first paragraph of Example 1 (5.0 g), benzaldehyde (514 mg, 4.8 mmol), 4-methoxybenzaldehyde (2.0 g, 14.5 mmol), 4-dimethylaminobenzaldehyde (722 mg, 4.84 mmol), toluene (75 mL) and piperidine acetate (100 mg) were added, respectively, to a 250 mL, 3-neck, round bottomed flask equipped with a magnetic stirrer and Dean-Stark trap. The reaction solution was heated to reflux and stirred until water distillation stopped (about 18 hours). The reaction mixture containing the light-absorbing polyester thus prepared was allowed to cool to room temperature and then concentrated to give 8.58 g of a light yellow oil.

### Example 3

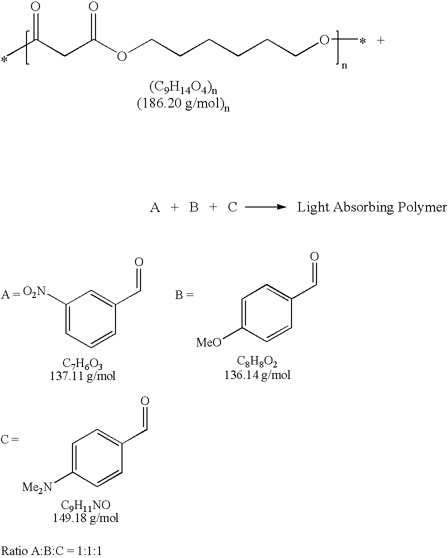

The polyester prepared as described in the first paragraph of Example 1 (5.0 g), 3-nitrobenzaldehyde (974 mg, 7.10 mmol), 4-methoxybenzaldehyde (967 mg, 7.1 mmol), 4-dimethylaminobenzaldehyde (1.06 g, 7.10 mmol), toluene (75 mL) and piperidine acetate (100 mg) were added, respectively, to a 250 mL 3-neck, round bottomed flask equipped with a magnetic stirrer and Dean-Stark trap. The reaction solution was heated to reflux and stirred until water distillation stopped (about 18 hours). The reaction mixture containing the light-absorbing polyester thus prepared was allowed to cool to room temperature and then concentrated to a light yellow oil.

### Example 4

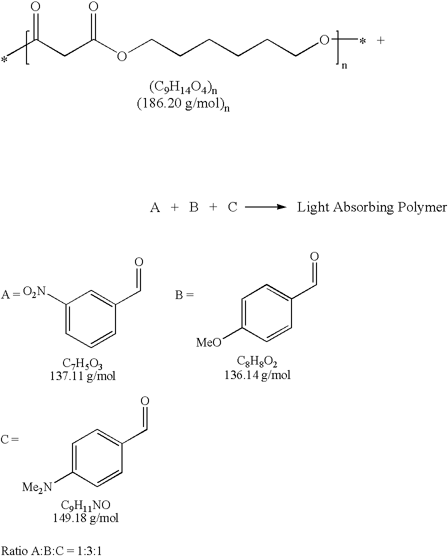

The polyester prepared as described in the first paragraph of Example 1 (5.0 g), 3-nitrobenzaldehyde (590 mg, 4.3 mmol), 4-methoxybenzaldehyde (1.76 g, 12.9 mmol), 4-dimethylaminobenzaldehyde (642 mg, 4.3 mmol), toluene (75 mL) and piperidine acetate (100 mg) were added, respectively, to a 250 mL, 3-neck, round bottomed flask equipped with a magnetic stirrer and Dean-Stark trap. The reaction solution was heated to reflux and stirred until water distillation stopped (about 18 hours). The reaction mixture containing the light-absorbing polyester thus prepared was allowed to cool to room temperature then concentrated to a light yellow oil.

### Example 5

An overprint coating composition base was prepared by dissolving a poly(methyl methacrylate) resin (21.7 g, Dianal BR-83, Dianal America, Inc.) in a solvent mixture consisting of butyl acetate (40.3 g), propylene glycol methyl ether acetate (35.7 g) and dibutyl phthalate (2.3 g). A portion of the light absorbing polyester of Example 3 (0.141 g) was added to a portion of the coating composition base (14.146 g) with stirring. The blended solution was drawn down on coated paper stock (Leneta N2C, Leneta Company, Mahwah, N.J.) with a #2 RK wirewound rod and allowed to dry at room temperature. A UV-VIS reflectance spectrum of the dried overprint coating composition displayed absorbance maxima for the separate chromophores of the polyester with maxima at 260 nm (30% absorbance), 322 nm (43% absorbance) and 374 nm (64% absorbance).

### Example 6

A portion of the light-absorbing polyester of Example 4 (0.102 g) was added to a portion of the above coating composition base (10.116 g) with stirring. The blended solution was drawn down on coated paper stock (Leneta N2C, Leneta Company, Mahwah, N.J.) with a #2 RK wirewound rod and allowed to dry at room temperature. A UV-VIS reflectance spectrum of the dried coating composition displayed absorbance maxima for the separate chromophores of the polyester at 260 nm (32% absorbance), 318 nm (67% absorbance), and 374 nm (49% absorbance) and distinguishable in peak intensities from the spectrum of Example 7.

The invention has been described in detail with particular reference to preferred embodiments thereof, but it will be understood that variations and modifications can be effected within the spirit and scope of the invention.

We claim:

1. A light-absorbing composition having the formula: 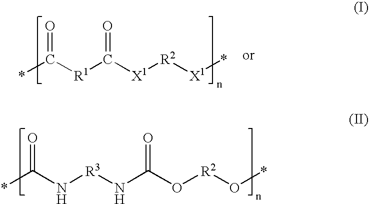
wherein
R¹is selected from C₁-C₁₂-alkylene, C₃-C₈-cycloalkylene, carbocyclic arylene, divalent residues of a plurality of methine compounds; and a combination of any two or more thereof;
R² is selected from C₂-C₁₂-alkylene; —C₂H₄(OC₂H₄)ₚ—, wherein p is 1 to about 100; C₃-C₈-cycloalkylene; C₁-C₁₂-alkylene-C₃-C₈-cycloalkylene-C₁-C₁₂-alkylene; divalent residues of a plurality of methine compounds; and a combination of any two or more thereof;
R³ is selected from C₄-C₁₂-alkylene; C₃-C₈-cycloalkylene; and carbocyclic arylene;
X¹ is —O— or —N(R⁴)—, wherein R⁴ is hydrogen, C₁-C₂₂-alkyl, substituted C₁-C₂₂-alkyl, C₃-C₈-cycloalkyl or carbocyclic aryl; and
n is an integer from 2 to about 100;
wherein the divalent residues of a plurality of methine compounds have the formulas: 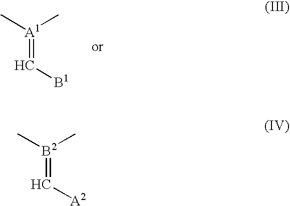
wherein
A¹ in combination with (i) the carbonyl groups to which R¹ is bonded or (ii) the X¹ groups to which R² is bonded is the divalent residues of an active methylene component of a light-absorbing methine compound;
B¹ represents the residues of a plurality of electron rich carbocyclic or heterocyclic aryl components of light-absorbing methine compounds;
B² in combination with (i) the carbonyl groups to which R¹ is bonded or (ii) the X¹ groups to which R² is bonded is the divalent residue of an electron rich carbocyclic or heterocyclic aryl component of a light-absorbing methine compound;
A² represents the residues of a plurality of active methylene components of light-absorbing methine compounds;
wherein the compositions of formulas (I) and (II) contain at least two different B¹ groups or at least two different A² groups.

2. A light-absorbing composition according to claim 1 having a weight average molecular weight (M_{w}) of about 1,000 to 25,000 having formulas (I) or (II) wherein
R¹ is selected from C₁-C₁₂-alkylene, C₃-C₈-cycloalkylene, carbocyclic arylene, divalent residues of a plurality of methine compounds; and a combination of any two or more thereof;
R² is selected from C₂-C₁₂-alkylene; —C₂H₄(OC₂H₄)ₚ—, wherein p is 1 to about 100; C₃-C₈-cycloalkylene; C₁-C₁₂-alkylene-C₃-C₈-cycloalkylene-C₁-C₁₂-alkylene; divalent residues of a plurality of methine compounds; and a combination of any two or more thereof;
R³ is selected from C₄-C₁₂-alkylene; C₃-C₈-cycloalkylene; and carbocyclic arylene;
X¹ is —O— or —N(R⁴)—, wherein R⁴ is hydrogen, C₁-C₂₂-alkyl, substituted C₁-C₂₂-alkyl, C₃-C₈-cycloalkyl or carbocyclic aryl; and
n is a integer from 2 to about 100;
wherein the divalent residues of a plurality of methine compounds have the formula: 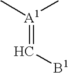
wherein
A¹ in combination with (i) the carbonyl groups to which R¹ is bonded or (ii) the X¹ groups to which R² is bonded is the divalent residues of an active methylene component of a light-absorbing methine compound; and
B¹ represents the residues of a plurality of electron rich carbocyclic or heterocyclic aryl components of light-absorbing methine compounds;
wherein the compositions of formulas (I) and (II) contain at least two different B¹ groups.

3. A light-absorbing composition according to claim 2 having a weight average molecular weight (M_{w}) of about 1,000 to 10,000 wherein X¹ is —O—.

4. A light-absorbing composition according to claim 2 having a weight average molecular weight (M_{w}) of about 1,000 to 10,000 wherein about 10 to 100 mole percent of the groups represented by —CO—R¹—CO— or the groups represented by —X¹—R²—X¹— have the formulas: 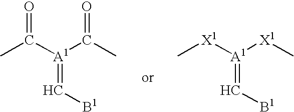
wherein -A¹- is the residue of an active methylene compound selected from the formulas: 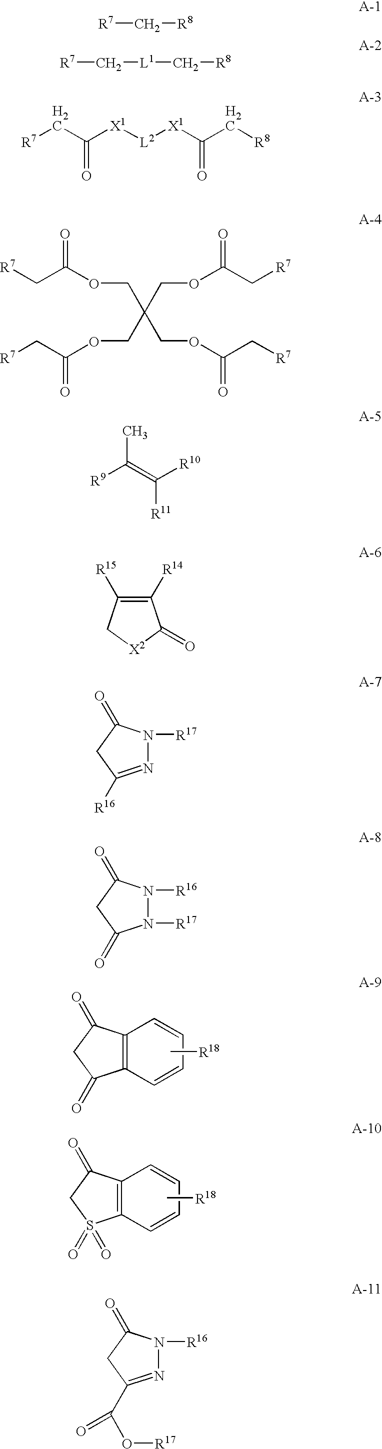 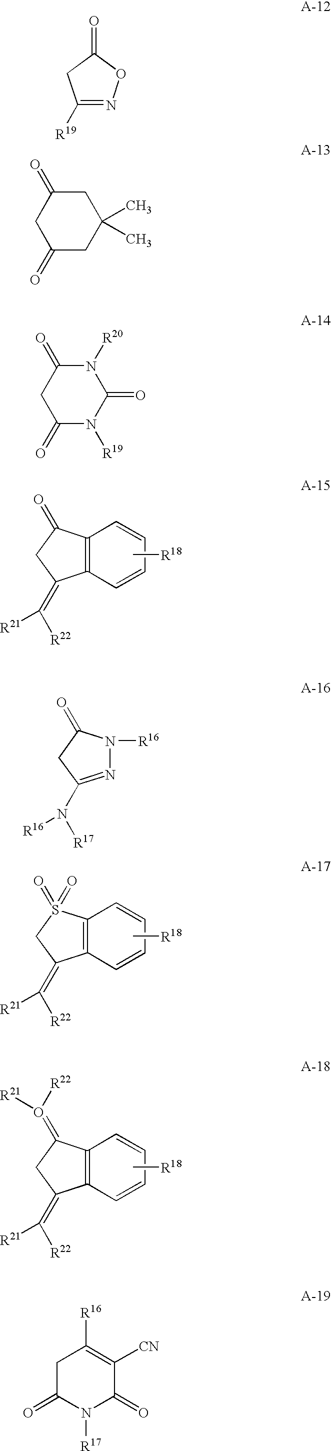 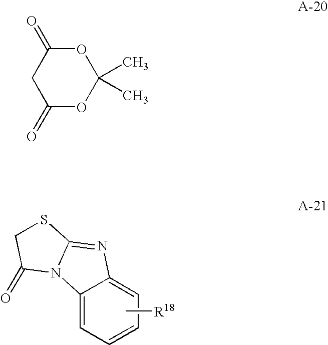
wherein
R⁷ and R⁸ each is an electron withdrawing group independently selected from aryl, carbamoyl, cyano, heteroaryl, nitro, sulfamoyl, —COR¹², —COOR¹², —CONHR¹², —CON(R¹²)R¹³, —SO₂R¹², —SO₂NHR¹², and —SO₂N(R¹²)R¹³;
R⁹ is selected from carbocyclic aryl and heterocyclic aryl;
R¹⁰ and R¹¹ each is independently selected from cyano, C₁-C₆-alkylsulfonyl, arylsulfonyl and C₁-C₆-alkoxycarbonyl;
R¹² and R¹³ individually are independently selected from C₁-C₂₂-alkyl; substituted C₁-C₂₂-alkyl, including groups having the formula -L²-OH and -L³-OH; —C₂H₄(OC₂H₄)ₚ—OH; C₃-C₈-cycloalkyl; substituted C₃-C₈-cycloalkyl; C₃-C₈-alkenyl; C₃-C₈-alkynyl;carbocyclic aryl; heterocyclic aryl; and R¹² and R¹³ collectively with the nitrogen atom to which R¹² and R¹³ are bonded may represent a cyclic group selected from pyrrolidino, piperidino, morpholino, piperazino, thiomorpholino and thiomorpholino-S,S-dioxide;
R¹⁴ is selected from C₁-C₆-alkoxycarbonyl, carboxy, carbamoyl, —CONHR¹², ——CON(R¹²)R¹³, cyano and heterocyclic aryl;
R¹⁵ is selected from carbocyclic aryl and heterocyclic aryl;
R¹⁶ and R¹⁷ each is independently selected from hydrogen, C₁-C₆-alkyl, —C₂H₄(OC₂H₄)ₚ—OH, substituted C₁-C₆-alkyl, C₃-C₈-cycloalkyl and carbocyclic aryl;
R¹⁸ is selected from hydrogen, C₁-C₆-alkyl, C₁-C₆-alkoxy, halogen, cyano, C₁-C₆-alkoxycarbonyl, trifluoromethyl, hydroxy, C₁-C₆-alkanoyloxy, aroyl, C₁-C₆-alkylthio, C₁-C₆-alkylsulfonyl, carbamoyl, sulfamoyl, —NHCOR¹², —NHSO₂R¹², —CONHR¹², —CON(R¹²)R¹³, —SO₂NHR¹² and —SO₂N(R¹²)R¹³.
R¹⁹ and R²⁰ are selected from hydrogen, C₁-C₆-alkyl, substituted C₁-C₆-alkyl and carbocyclic aryl;
R²¹ and R²² each is independently selected from cyano, C₁-C₆-alkylsulfonyl, carbocyclic arylsulfonyl, C₁-C₆-alkoxycarbonyl and heterocyclic aryl;
L¹ is arylene;
L² and L³ each is a divalent linking group selected from C₂-C₂₂-alkylene, C₃-C₈-cycloalkylene, C₁-C₆-alkylene-cyclohexylene-C₁-C₆-alkylene, C₂-C₄-alkylene-O-arylene-O-C₂-C₄-alkylene, arylene and —(CH₂CH₂-L₄)₁₋₃-CH₂CH₂—, wherein L₄ is selected from —O—, —S—, —SO₂—, and —N(R⁴)—;
X² is selected from —O—, —S— and —N(R⁴)—; and
p, R⁴, X¹ and B¹ are defined in claim 2.

5. A light-absorbing composition according to claim 4 wherein B¹ represents a plurality of electron rich carbocyclic or heterocyclic aryl groups having the formulas: 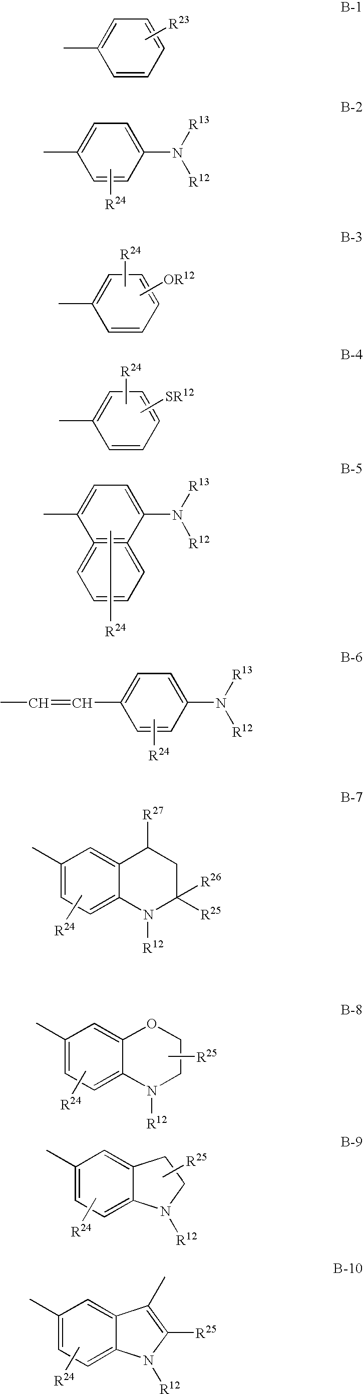 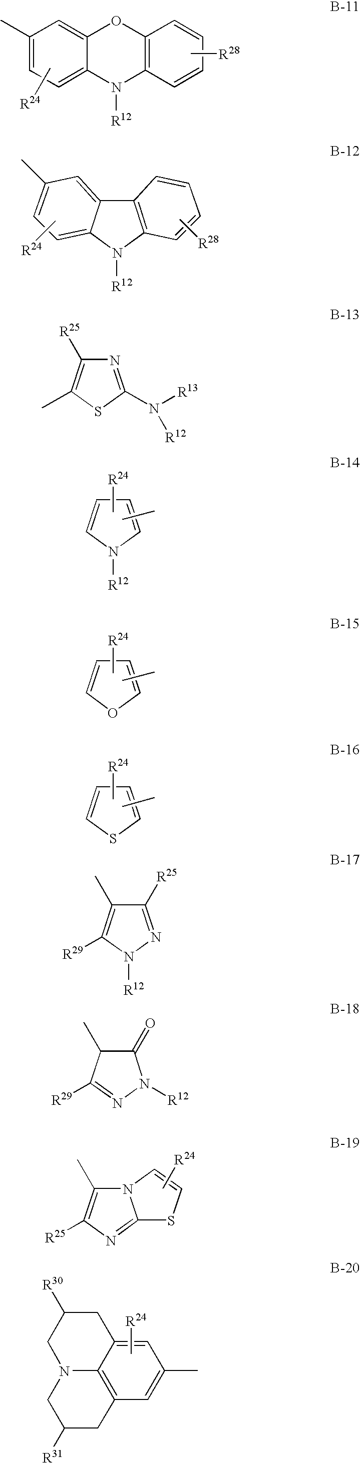 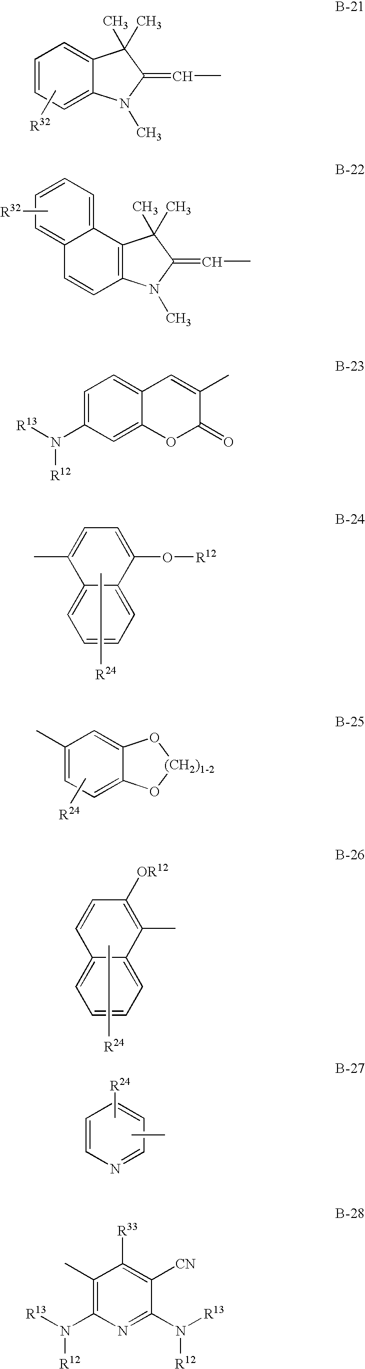
wherein:
R²³ is selected from hydrogen and one or two groups selected from carboxy, C₁-C₆⁻ alkoxycarbonyl, —CON(R¹²R¹³, —N(R¹⁶)COR^{17,}, —N(R¹⁶)SO₂R³⁴, —N(R¹⁶)CON(R¹⁶)R¹⁷, succinimido, phthalimido, halogen, nitro, trifluoromethyl, —OCOR³⁴ and carbocyclic aryl;
R²⁴ is selected from hydrogen and one or two groups selected from C₁-C₆-alkyl, substituted C₁-C₆-alkyl, C₁-C₆-alkoxy and hydrogen;
R²⁵ is selected from hydrogen, C₁-C₆-alkyl and aryl;
R²⁶ and R²⁷ are selected from hydrogen and C₁-C₆-alkyl;
R²⁸ is selected from hydrogen and one or two groups selected from C₁-C₆-alkyl, C₁-C₆-alkoxy and halogen;
R²⁹ is selected from hydrogen, C₁-C₆-alkyl, C₃-C₈-cycloalkyl, aryl, —CO₂R¹⁶ and —N(R¹²)R¹³;
R³⁰ and R³¹ are selected from hydrogen and C₁-C₆-alkyl;
R³² is selected from hydrogen, C₁-C₆-alkyl, C₁-C₆-alkoxy, carboxy and —CO₂R₁₇;
R³³ is selected from C₁-C₆-alkyl, C₃-C₈-cycloalkyl and carbocyclic and heterocyclic aryl;
R³⁴ is selected from C₁-C₆-alkyl, C₃-C₈-cycloalkyl and carbocyclic aryl; and
R^{12,} R¹³, R¹⁶ and R¹⁷ are defined in claim 4.

6. A light-absorbing composition having a weight average molecular weight (M_{w}) of about 1,000 to 25,000 having the formula: 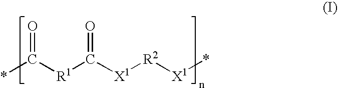
wherein
R¹ is selected from C₁-C₁₂-alkylene, C₃-C₈-cycloalkylene, carbocyclic arylene, divalent residues of a plurality of methine compounds; and a combination of any two or more thereof;
R² is selected from C₂-C₁₂-alkylene; —C₂H₄(OC₂H₄)ₚ—, wherein p is 1 to about 3; C₃-C₈-cycloalkylene; C₁-C₁₂-alkylene-C₃-C₈-cycloalkylene-C₁-C₁₂-alkylene; and a combination of any two or more thereof;
n is a integer from 2 to about 100;
wherein 10 to 100 mole percent of the —CO—R¹—CO— groups are divalent residues of a plurality of methine compounds having the formula: 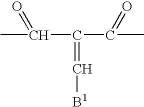
wherein B¹ represents a plurality of aryl groups selected from groups having the formulas: 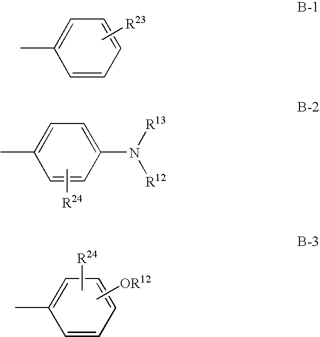
wherein:
R¹² and R¹³ individually are independently selected from C₁-C₂₂-alkyl; substituted C₁-C₂₂-alkyl, including groups having the formula -L²—OH and -L³—OH; —C₂H₄(OC₂H₄)ₚ—OH; C₃-C₈-cycloalkyl; substituted C₃-C₈-cycloalkyl; C₃-C₈-alkynyl; C₃-C₈-alkynyl; carbocyclic aryl; heterocyclic aryl; and R¹² and R¹³ collectively with the nitrogen atom to which R¹² and R¹³ are bonded may represent a cyclic group selected from pyrrolidino, piperidino, morpholino, piperazino, thiomorpholino and thiomorpholino-S, S-dioxide;
R²³ is selected from hydrogen and one or two groups selected from carboxy, C₁-C₆⁻ alkoxycarbonyl, —CON(R¹²R¹³, —N(R¹⁶)COR^{17,}, —N(R¹⁶)SO₂R³⁴, —N(R¹⁶)CON(R¹⁶)R¹⁷, succinimido, phthalimido, halogen, nitro, trifluoromethyl, —OCOR³⁴ and carbocyclic aryl; and
p is 1, 2 or 3.

7. A light-absorbing composition according to claim 6 having a weight average molecular weight (M_{w}) of about 1,000 to 10,000 wherein
R¹ is selected from C₁-C₁₂-alkylene, C₃-C₈-cycloalkylene, carbocyclic arylene, divalent residues of three methine compounds; and a combination of any two or more thereof;
R² is selected from C₂-C₁₂-alkylene; —C₂H₄(OC₂H₄)ₚ—, wherein p is 1 to about 3; C₃-C₈-cycloalkylene; C₁-C₁₂-alkylene-C₃-C₈-cycloalkylene-C₁-C₁₂-alkylene; and a combination of any two or more thereof;
n is a integer from 2 to about 100;
wherein 10 to 100 mole percent of the —CO—R¹—CO— groups are divalent residues of three methine compounds having the formula: 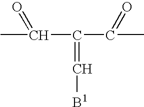
wherein B¹ represents three different aryl groups selected from groups having the formulas: 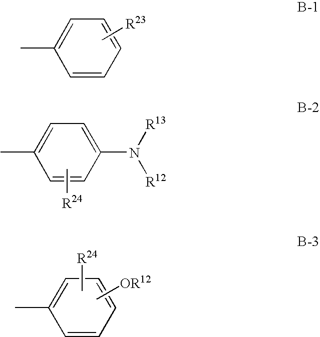
wherein:
R¹² and R¹³ individually are independently selected from C₁-C₆-alkyl; —CH₂-aryl, 2-cyanoethyl, 2-hydroxethyl, 2-acetoxyethyl, cyclohexyl or R¹² and R¹³ are combined to represent, with the nitrogen atom to which they are bonded, piperidino, morpholino and thiomorpholino-S,S-dioxide;
R²³ is hydrogen or one or two groups selected from methyl, methoxycarbonyl, halogen and nitro; and
R²⁴ is hydrogen or one or two groups selected from methyl, methoxy and halogen.

8. A coating composition comprising a light-absorbing composition defined in claim 1, a polymeric film-forming composition and an inert, organic solvent.

9. A coating composition comprising a light-absorbing composition defined in claim 2, a polymeric film-forming composition and an inert, organic solvent, wherein the light-absorbing composition constitutes about 0.1 to 10 weight percent of the total weight of the coating composition.

10. A coating composition comprising about 0.1 to 10 weight percent of a light-absorbing composition defined in claim 5, about 10.0 to 50.0 weight percent of a polymeric film-forming composition selected from acrylics, polyesters and cellulose esters and an inert, organic solvent.

11. A coating composition comprising about 0.1 to 10 weight percent of a light-absorbing composition defined in claim 6, about 15.0 to 30.0 weight percent of a polymeric film-forming composition selected from acrylics, polyesters and cellulose esters and an inert, organic solvent.

12. An article coated with the coating composition defined in claim 8.

13. Packaging material coated with the coating composition defined in claim 8.

14. Packaging material coated with a coating comprising a film of a polymeric film-forming composition containing a light-absorbing composition defined in claim 1.

15. Packaging material coated with a coating comprising a film of a polymeric film-forming composition containing a light-absorbing composition defined in claim 5.

16. Packaging material coated with a coating comprising a film of a polymeric film-forming composition selected from acrylics, polyesters and cellulose esters containing a light-absorbing composition defined in claim 6.

17. A bulk material containing a marking-effective amount of a light-absorbing composition defined in claim 1.

18. A bulk material containing a marking-effective amount of a light-absorbing composition defined in claim 2.

19. A bulk material containing about 0.01 to 1.0 weight percent of a light-absorbing composition defined in claim 8.

20. A bulk material selected from solid and liquid chemicals and liquid fuels containing about 0.01 to 1.0 weight percent of a light-absorbing composition defined in claim 1.

21. Process for the preparation of a composition having the formula: 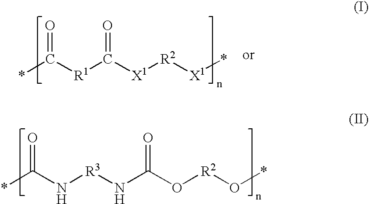
which comprises contacting a composition having the formula: 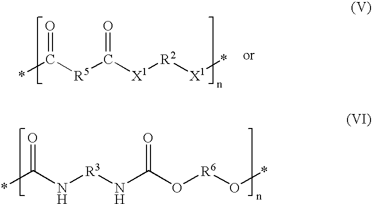
with a plurality of active methylene compounds having the formula A²-H₂, a plurality of carbocyclic or heterocyclic aryl aldehydes having the formula OCH—B¹, or a combination thereof;
wherein
R¹ is selected from C₁-C₁₂-alkylene, C₃-C₈-cycloalkylene, carbocyclic arylene, divalent residues of a plurality of methine compounds; and a combination of any two or more thereof;
R² is selected from C₂-C₁₂-alkylene; —C₂H₄(OC₂H₄)ₚ—, wherein p is 1 to about 100; C₃-C₈-cycloalkylene; C₁-C₁₂-alkylene-C₃-C₈-cycloalkylene-C₁-C₁₂-alkylene; divalent residues of a plurality of methine compounds; and a combination of any two or more thereof;
R³ is selected from C₄-C₁₂-alkylene; C₃-C₈-cycloalkylene; and carbocyclic arylene;
R⁵ is selected from C₁-C₁₂-alkylene; C₃-C₈-cycloalkylene; carbocyclic arylene; a divalent residue having the formula 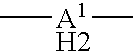
containing an active methylene, a divalent residue of an aromatic aldehyde having the formula 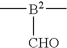
and a combination of any two or more thereof;
R⁶ is selected from C₂-C₁₂-alkylene; C₂H₄(OC₂H₄)ₚ—wherein p 1 to about 100; C₃-C₈-cycloalkylene; C₁-C₁₂-alkylene-C₃-C₈-cycloalkylene-C₁-C₁₂-alkylene; a divalent, active methylene-containing residue having the formula 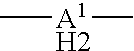
a divalent aldehyde-containing residue having the formula 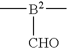
or a combination of any two or more thereof;
X¹ is —O— or —N(R⁴)—, wherein R⁴ is hydrogen, C₁-C₂₂-alkyl, substituted C₁-C₂₂-alkyl, C₃-C₈-cycloalkyl or carbocyclic aryl; and
n is an integer from 2 to about 100;
wherein the divalent residues of a plurality of methine compounds have the formulas: 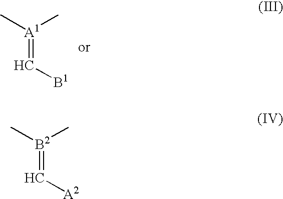
wherein
A¹ in combination with (i) the carbonyl groups to which R¹ is bonded or (ii) the X¹ groups to which R² is bonded is the divalent residues of an active methylene component of a light-absorbing methine compound;
B¹ represents the residues of a plurality of carbocyclic or heterocyclic aryl components of light-absorbing methine compounds;
B² in combination with (i) the carbonyl groups to which R¹ is bonded or (ii) the X¹ groups to which R² is bonded is the divalent residues of a carbocyclic or heterocyclic aryl component of a light-absorbing methine compound;
A² represents the residues of a plurality of active methylene components of light-absorbing methine compounds;
wherein the compositions of formulas (I) and (II) contain at least two different B¹ groups or at least two different A² groups.

22. A process according to claim 21 wherein the light-absorbing composition has a weight average (M_{w}) molecular weight of about 1,000 to 25,000 which comprises contacting a composition having formula (V) or (VI) with a plurality of carbocyclic or heterocyclic aryl aldehydes having the formula OCH—B¹ at a temperature of about 25 to 150° C.;
wherein
R¹ is selected from C₁-C₁₂-alkylene, C₃-C₈-cycloalkylene, carbocyclic arylene, divalent residues of a plurality of methine compounds; and a combination of any two or more thereof;
R² is selected from C₂-C₁₂-alkylene; —C₂H₄(OC₂H₄)ₚ—, wherein p is 1 to about 100; C₃-C₈-cycloalkylene; C₁-C₁₂-alkylene-C₃-C₈-cycloalkylene-C₁-C₁₂-alkylene; divalent residues of a plurality of methine compounds; and a combination of any two or more thereof;
R³ is selected from C₄-C₁₂-alkylene; C₃-C₈-cycloalkylene; and carbocyclic arylene;
R⁵ is selected from C₁-C₁₂-alkylene; C₃-C₈-cycloalkylene; carbocyclic arylene; a divalent residue having the formula 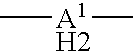
containing an active methylene; and a combination of any two or more thereof;
R⁶ is selected from C₂-C₁₂-alkylene; C₂H₄(OC₂H₄)ₚ—wherein p 1 to about 100; C₃-C₈-cycloalkylene; C₁-C₁₂-alkylene-C₃-C₈-cycloalkylene-C₁-C₁₂-alkylene; divalent, active methylene-containing residue having the formula 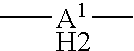
or a combination of any two or more thereof;
X¹ is —O— or —N(R⁴)—, wherein R⁴ is hydrogen, C₁-C₂₂-alkyl, substituted C₁-C₂₂-alkyl, C₃-C₈-cycloalkyl or carbocyclic aryl; and
n is a integer from 2 to about 100;
wherein the divalent residues of a plurality of methine compounds have the formula: 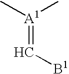
wherein
A¹ in combination with (i) the carbonyl groups to which R¹ is bonded or (ii) the X¹ groups to which R² is bonded is the divalent residues of an active methylene component of a light-absorbing methine compound; and
B¹ represents the residues of a plurality of carbocyclic or heterocyclic aryl components of light-absorbing methine compounds;
wherein the compositions of formulas (I) and (II) contain at least two different B¹ groups.

23. A process according to claim 22 wherein X¹ is —O— and about 10 to 100 mole percent of the groups represented by —CO—R¹—CO— or the groups represented by —X¹—R²—X¹— have the formulas: 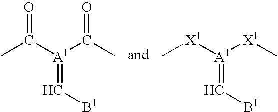
wherein -A¹- is the residue of an active methylene compound having the formulas: 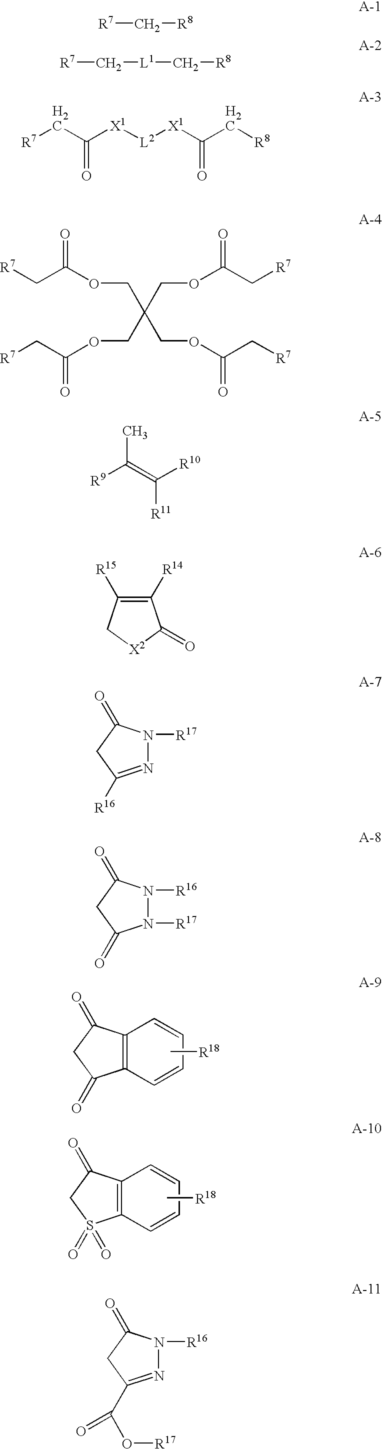 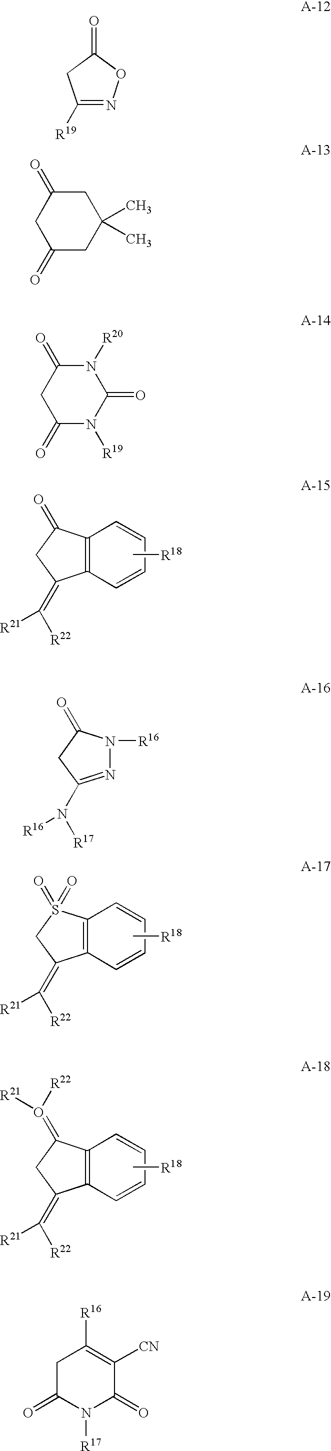 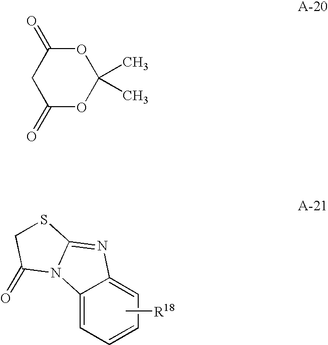
wherein
R⁷ and R⁸ each is an electron withdrawing group independently selected from aryl, carbamoyl, cyano, heteroaryl, nitro, sulfamoyl, —COR¹², —COOR¹², —CONHR¹², —CON(R¹²)R¹³, —SO₂R¹², —SO₂NHR¹², and —SO₂N(R¹²)R¹³;
R⁹ is selected from carbocyclic aryl and heterocyclic aryl;
R¹⁰ and R¹¹ each is independently selected from cyano, C₁-C₆-alkylsulfonyl, arylsulfonyl and C₁-C₆-alkoxycarbonyl;
R¹² and R¹³ individually are independently selected from C₁-C₂₂-alkyl; substituted C₁-C₂₂-alkyl, including groups having the formula -L²-OH and -L³-OH; —C₂H₄(OC₂H₄)ₚ—OH; C₃-C₈-cycloalkyl; substituted C₃-C₈-cycloalkyl; C₃-C₈-alkenyl; C₃-C₈-alkynyl; carbocyclic aryl; heterocyclic aryl; and R¹² and R¹³ collectively with the nitrogen atom to which R¹² and R¹³ are bonded may represent a cyclic group selected from pyrrolidino, piperidino, morpholino, piperazino, thiomorpholino and thiomorpholino-S,S-dioxide;
R¹⁴ is selected from C₁-C₆-alkoxycarbonyl, carboxy, carbamoyl, —CONHR¹², ——CON(R¹²)R¹³, cyano and heterocyclic aryl;
R¹⁵ is selected from carbocyclic aryl and heterocyclic aryl;
R¹⁶ and R¹⁷ each is independently selected from hydrogen, C₁-C₆-alkyl, —C₂H₄(OC₂H₄)ₚ—OH, substituted C₁-C₆-alkyl, C₃-C₈-cycloalkyl and carbocyclic aryl;
R¹⁸ is selected from hydrogen, C₁-C₆-alkyl, C₁-C₆-alkoxy, halogen, cyano, C₁-C₆-alkoxycarbonyl, trifluoromethyl, hydroxy, C₁-C₆-alkanoyloxy, aroyl, C₁-C₆-alkylthio, C₁-C₆-alkylsulfonyl, carbamoyl, sulfamoyl, —NHCO R¹², —NHSO₂R¹², —CONHR¹², —CON(R¹²)R¹³, —SO₂NHR¹² and —SO₂N(R¹²)R¹³.
R¹⁹ and R²⁰ are selected from hydrogen, C₁-C₆-alkyl, substituted C₁-C₆-alkyl and carbocyclic aryl;
R²¹ and R²² each is independently selected from cyano, C₁-C₆-alkylsulfonyl, carbocyclic arylsulfonyl, C₁-C₆-alkoxycarbonyl and heterocyclic aryl;
L¹ is arylene;
L² and L³ each is a divalent linking group selected from C₂-C₂₂-alkylene, C₃-C₈-cycloalkylene, C₁-C₆-alkylene-cyclohexylene-C₁-C₆-alkylene, C₂-C₄-alkylene-O-arylene-O—C₂-C₄-alkylene, arylene and —(CH₂CH₂-L₄)₁₋₃—CH₂CH₂—, wherein L₄ is selected from —O—, —S—, —SO₂—, and —N(R⁴)—;
X² is selected from —O—, —S— and —N(R⁴)—; and
p, R⁴ and B¹ are defined in claim 18.

24. A process according to claim 23 wherein X¹ is —O— and B¹ represents a plurality of carbocyclic or heterocyclic aryl groups having the formulas: 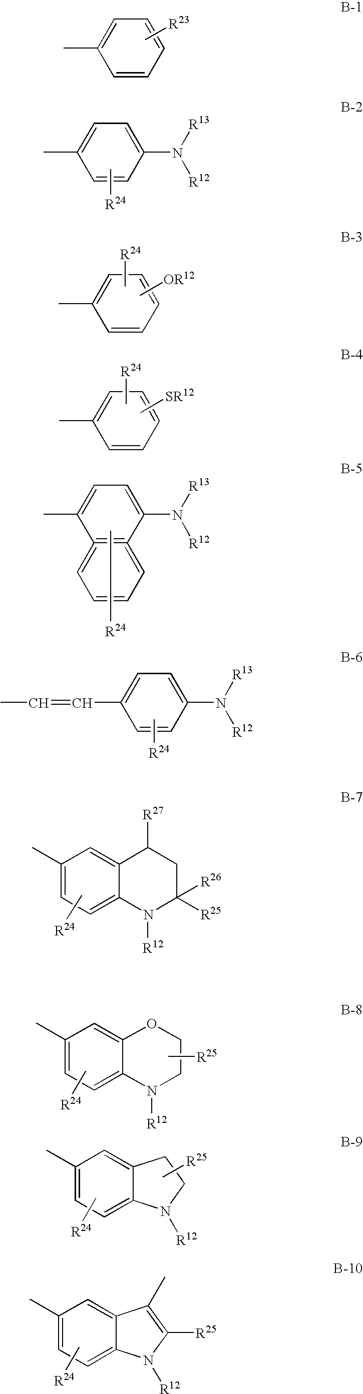 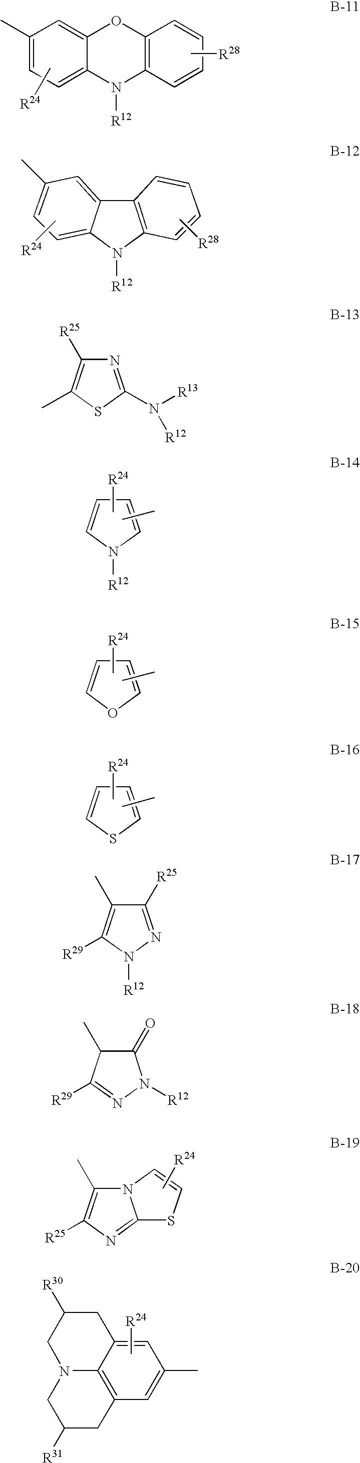 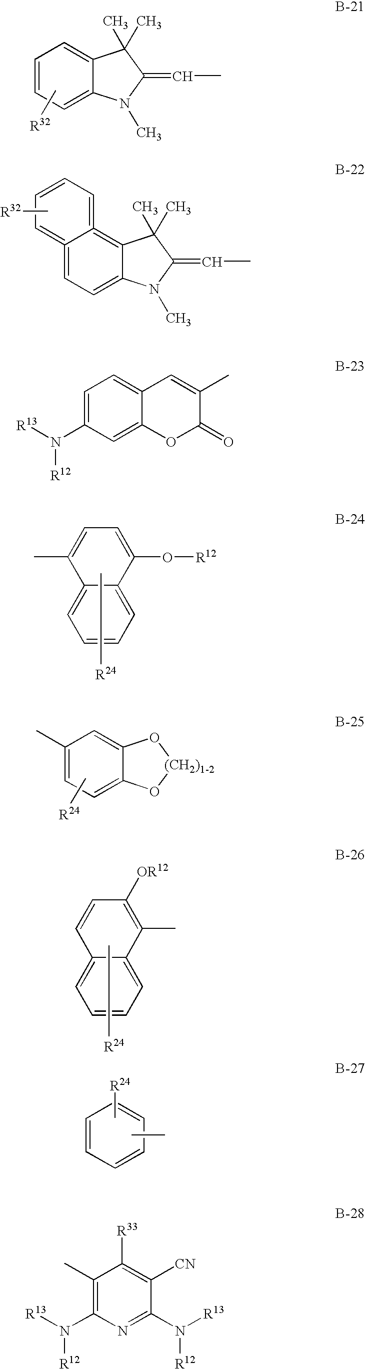
wherein:
R²³ is selected from hydrogen and one or two groups selected from carboxy, C₁-C₆⁻alkoxycarbonyl, —CON(R¹²R¹³, —N(R¹⁶)COR^{17,}, —N(R¹⁶)SO₂R³⁴, —N(R¹⁶)CON(R¹⁶)R¹⁷, succinimido, phthalimido, halogen, nitro, trifluoromethyl, —OCOR³⁴ and carbocyclic aryl;
R²⁴ is selected from hydrogen and one or two groups selected from C₁-C₆-alkyl, C₁-C₆-alkoxy and hydrogen;
R²⁵ is selected from hydrogen, C₁-C₆-alkyl and aryl;
R²⁶ and R²⁷ are selected from hydrogen and C₁-C₆-alkyl;
R²⁸ is selected from hydrogen and one or two groups selected from C₁-C₆-alkyl, C₁-C₆-alkoxy and halogen;
R²⁹ is selected from hydrogen, C₁-C₆-alkyl, C₃-C₈-cycloalkyl, aryl, —CO₂R¹⁶ and —N(R¹²)R¹³;
R³⁰ and R³¹ are selected from hydrogen and C₁-C₆-alkyl;
R³² is selected from hydrogen, C₁-C₆-alkyl, C₁-C₆-alkoxy, carboxy and —CO₂R¹⁷;
R³³ is selected from C₁-C₆-alkyl, C₃-C₈-cycloalkyl and carbocyclic and heterocyclic aryl;
R³⁴ is selected from C₁-C₆-alkyl, C₃-C₈-cycloalkyl and carbocyclic aryl; and
R^{12,} R¹³, R¹⁶ and R¹⁷ are defined in claim 19.

25. Process for the preparation of a light-absorbing composition having a weight average molecular weight (M_{w}) of about 1,000 to 25,000 and the formula: 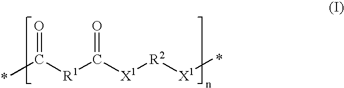
which comprises contacting a composition having formula: 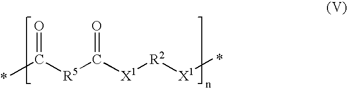
with a plurality of carbocyclic aryl aldehydes having the formula OCH—B¹ at a temperature of about 25 to 125° C. in the presence of an inert, organic solvent;
wherein
R¹ is selected from C₁-C₁₂-alkylene, C₃-C₈-cycloalkylene, carbocyclic arylene, divalent residues of a plurality of methine compounds; and a combination of any two or more thereof;
R² is selected from C₂-C₁₂-alkylene; —C₂H₄(OC₂H₄)ₚ—, wherein p is 1 to about 100; C₃-C₈-cycloalkylene; C₁-C₁₂-alkylene-C₃-C₈-cycloalkylene-C₁-C₁₂-alkylene; and a combination of any two or more thereof;
R⁵ is selected from C₁-C₁₂-alkylene; C₃-C₈-cycloalkylene; carbocyclic arylene; a divalent residue having the formula 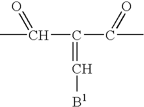
and a combination of any two or more thereof provided that 10 to 100 mole percent of the —CO—R⁵—CO— groups are divalent residues having the formula 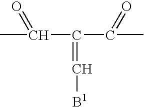
n is a integer from 2 to about 100;
wherein 10 to 100 mole percent of the —CO—R¹—CO— groups are divalent residues of a plurality of methine compounds having the formula: 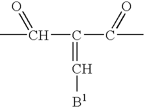
wherein B¹ represents a plurality of aryl groups selected from groups having the formulas: 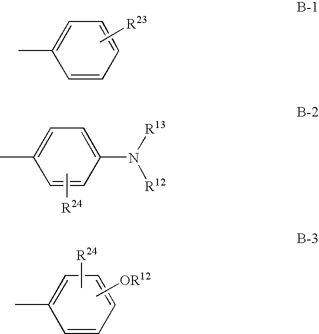
wherein:
R¹² and R¹³ individually are independently selected from C₁-C₂₂-alkyl; substituted C₁-C₂₂-alkyl, including groups having the formula -L²-OH and -L³-OH; —C₂H₄(OC₂H₄)ₚ—OH; C₃-C₈-cycloalkyl; substituted C₃-C₈-cycloalkyl; C₃-C₈-alkenyl; C₃-C₈-alkynyl; carbocyclic aryl; heterocyclic aryl; and R¹² and R¹³ collectively with the nitrogen atom to which R¹² and R¹³ are bonded may represent a cyclic group selected from pyrrolidino, piperidino, morpholino, piperazino, thiomorpholino and thiomorpholino-S,S-dioxide;
R²³ is selected from hydrogen and one or two groups selected from carboxy, C₁-C₆⁻alkoxycarbonyl, —CON(R¹²R¹³, —N(R¹⁶)COR^{17,}, —N(R¹⁶)SO₂R³⁴, —N(R¹⁶)CON(R¹⁶)R¹⁷, succinimido, phthalimido, halogen, nitro, trifluoromethyl, —OCOR³⁴ and carbocyclic aryl; and
p is 1, 2 or 3.
